(19) United States
(12) Patent Application Publication
(10) Pub. No.: US 2026/0133821 A1
(43) Pub. Date: May 14, 2026

(54) DOORBELL PHYSICAL INTERRUPT CONTROL

(71) Applicant: Arm Limited, Cambridge (GB)

(72) Inventor: Christoffer Dall, Copenhagen (DK)

(73) Assignee: Arm Limited, Cambridge (GB)

(21) Appl. No.: 18/868,304

(22) PCT Filed: Mar. 7, 2023
(86) PCT No.: PCT/GB2023/050532

§ 371 Date: Nov. 22, 2024

(30) Foreign Application Priority Data
May 31, 2022 (GB) 2208017.0

(51) Int. Cl. G06F 9/48; G06F 9/455

(52) U.S. Cl. CPC G06F 9/4812; G06F 9/45558; G06F 2009/45579; G06F 2009/45591

(57) ABSTRACT

Doorbell physical interrupt control circuitry (20) comprises interrupt detection circuitry (22) to detect an incoming interrupt to be raised as a given virtual interrupt (having a given priority) for a given virtual interrupt handling context, and doorbell physical interrupt generation circuitry (24) responsive to detection of the incoming interrupt by the interrupt detection circuitry, to determine whether the given priority of the given virtual interrupt is indicated, by doorbell-enabled-priority configuration data (28), as enabled for doorbell physical interrupt generation, and if so, to generate a doorbell physical interrupt to be processed in a given physical interrupt handling context. The doorbell physical interrupt indicates to a physical processor handling interrupts for the given physical interrupt handling context that the given virtual interrupt is pending for the given virtual interrupt handling context.

The present technique relates to the field of interrupt control.

In a data processing system, an interrupt controller has the job of detecting interrupts raised by one or more interrupt sources and signalling the interrupts to a physical or virtual processor responsible for handling interrupt.

At least some examples provide doorbell physical interrupt control circuitry comprising: interrupt detection circuitry to detect an incoming interrupt to be raised as a given virtual interrupt for a given virtual interrupt handling context, the given virtual interrupt having a given priority; and doorbell physical interrupt generation circuitry responsive to detection of the incoming interrupt by the interrupt detection circuitry, to: determine whether the given priority of the given virtual interrupt is indicated, by doorbell-enabled-priority configuration data indicative of which virtual interrupt priorities are enabled for doorbell physical interrupt generation, as enabled for doorbell physical interrupt generation; and in response to determining that the doorbell-enabled-priority configuration data indicates that the given priority of the given virtual interrupt is enabled for doorbell physical interrupt generation, generate a doorbell physical interrupt to be processed in a given physical interrupt handling context, the doorbell physical interrupt comprising a physical interrupt to indicate to a physical processor handling interrupts for the given physical interrupt handling context that the given virtual interrupt is pending to be handled in the given virtual interrupt handling context.

At least some examples provide an interrupt controller comprising: virtual interrupt injecting circuitry to support direct injection of virtual interrupts to a virtual processor executing on a physical processor; and the doorbell physical interrupt control circuitry described above.

At least some examples provide an apparatus comprising: one or more physical processors; an interrupt controller to distribute virtual interrupts and physical interrupts to the one or more physical processors; and the doorbell physical interrupt control circuitry described above.

At least some examples provide a computer-readable medium to store code for fabrication of the doorbell physical interrupt control circuitry, the interrupt controller, or the apparatus described above. The computer-readable medium may be a non-transitory storage medium.

At least some examples provide a first method comprising: detecting an incoming interrupt to be raised as a given virtual interrupt for a given virtual interrupt handling context, the given virtual interrupt having a given priority; and in response to detection of the incoming interrupt: determining whether the given priority of the given virtual interrupt is indicated as enabled for doorbell physical interrupt generation by doorbell-enabled-priority configuration data indicative of which virtual interrupt priorities are enabled for doorbell physical interrupt generation; and in response to determining that the doorbell-enabled-priority configuration data indicates that the given priority of the given virtual interrupt is enabled for doorbell physical interrupt generation, generating a doorbell physical interrupt to be processed in a given physical interrupt handling context, the doorbell physical interrupt comprising a physical interrupt to indicate to a physical processor handling interrupts for the given physical interrupt handling context that the given virtual interrupt is pending to be handled in the given virtual interrupt handling context.

At least some examples provide a second method comprising: in response to detecting that a first virtual interrupt of a first virtual interrupt handling context is to be serviced by a first virtual processor handling virtual interrupts for the first virtual interrupt handling context: determining whether a first priority of the first virtual interrupt is higher than a current priority associated with processing performed by a second virtual processor executing on a given physical processor, the second virtual processor handling virtual interrupts for a second virtual interrupt handling context; and in response to determining that the first priority is higher than the current priority: setting doorbell-enabled-priority configuration data associated with the second virtual interrupt handling context, the doorbell-enabled-priority configuration data comprising software-programmable data indicating, for the given virtual interrupt handling context, which priorities of interrupts are enabled or disabled for generation of a doorbell physical interrupt for indicating that a virtual interrupt is pending; and rescheduling the given physical processor to process the first virtual processor; wherein the doorbell-enabled-priority configuration data associated with the second virtual interrupt handling context is set to indicate, as disabled for generation of the doorbell physical interrupt, one or more priorities selected based on the first priority of the first virtual interrupt that detected for the first virtual interrupt handling context.

At least some examples provide a computer program which, when executed by a computer, controls the computer to perform the second method described above. The computer program may be stored on a storage medium. The storage medium may be a non-transitory storage medium.

Further aspects, features and advantages of the present technique will be apparent from the following description of examples, which is to be read in conjunction with the accompanying drawings, in which:

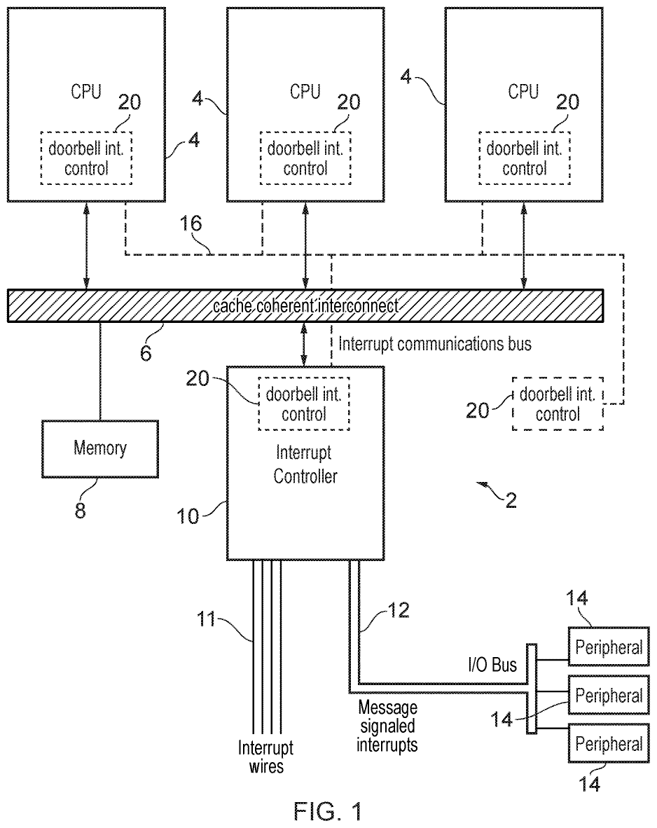

FIG. 1 illustrates an example of an apparatus having one or more processors, an interrupt controller and doorbell physical interrupt control circuitry;

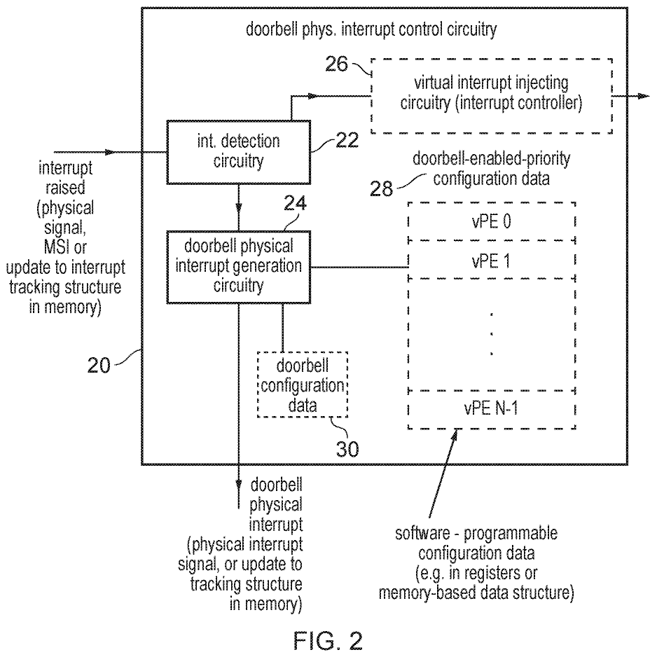

FIG. 2 illustrates the doorbell physical interrupt control circuitry;

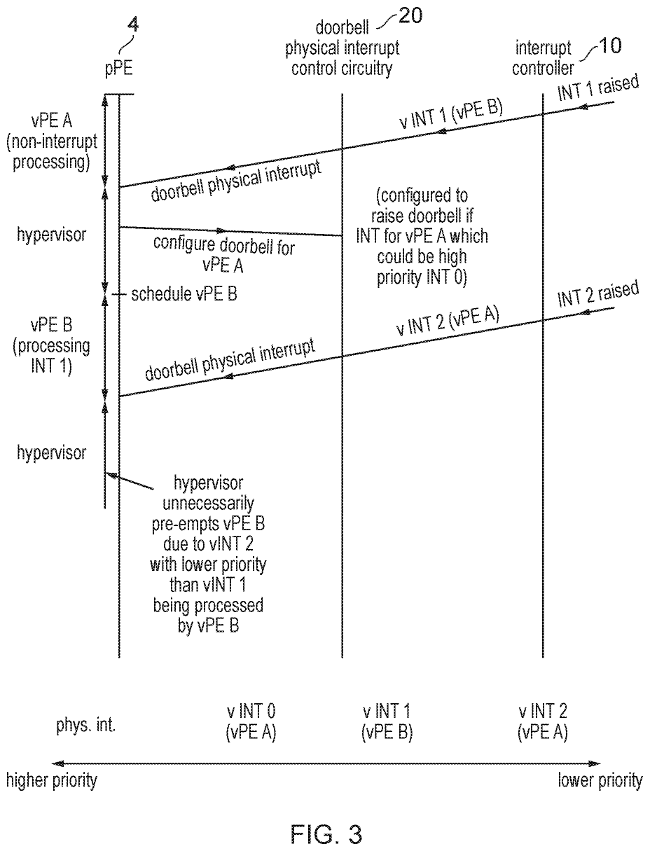

FIG. 3 is a ladder diagram illustrating a problem which arises in generating a doorbell physical interrupt to indicate to a physical processor that there is a pending virtual interrupt;

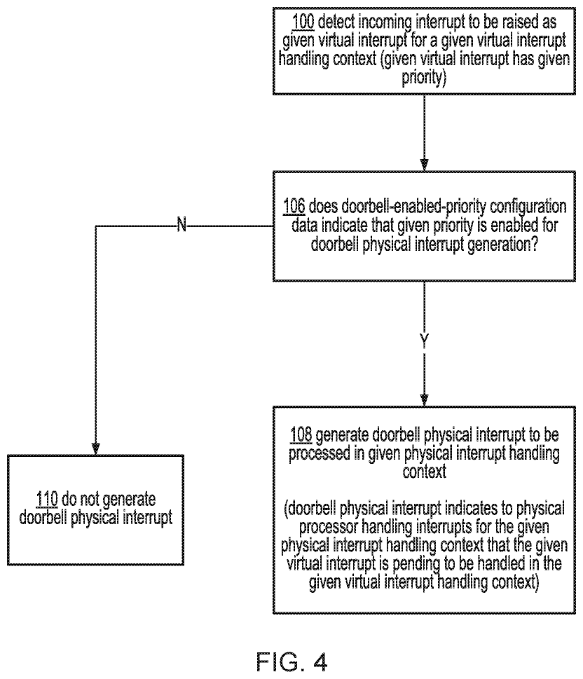

FIG. 4 is a flow diagram illustrating a method of using doorbell-enabled-priority configuration data to determine whether to generate a doorbell physical interrupt in response to a given virtual interrupt;

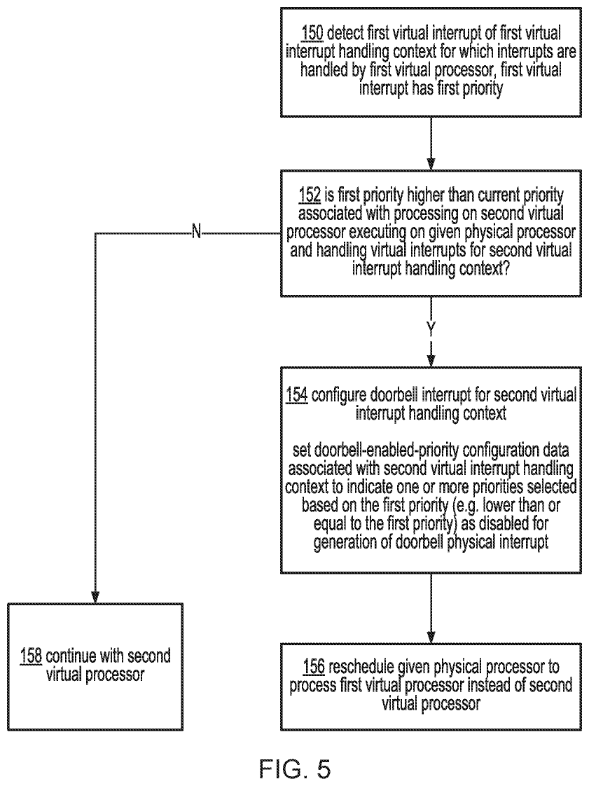

FIG. 5 is a flow diagram illustrating a method performed by software (e.g. a hypervisor) to configure the doorbell-enabled-priority configuration data;

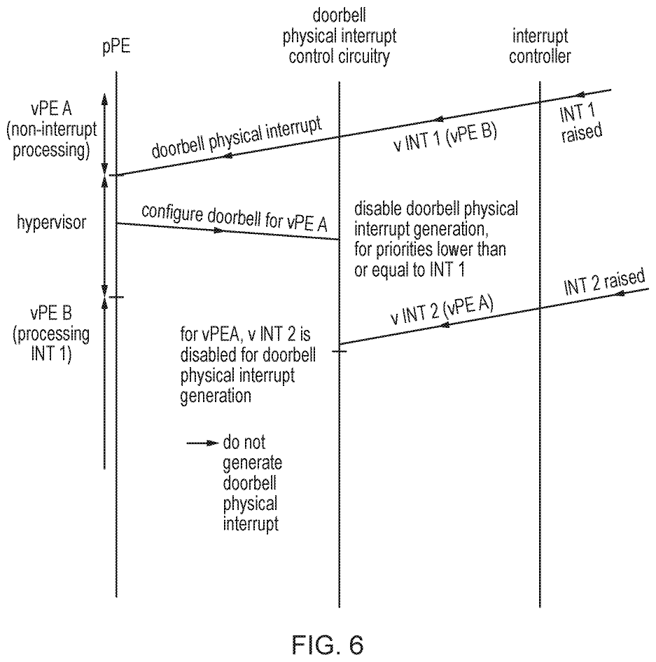

FIG. 6 is a ladder diagram illustrating an example of applying the method of FIG. 4 to the scenario shown in FIG. 3;

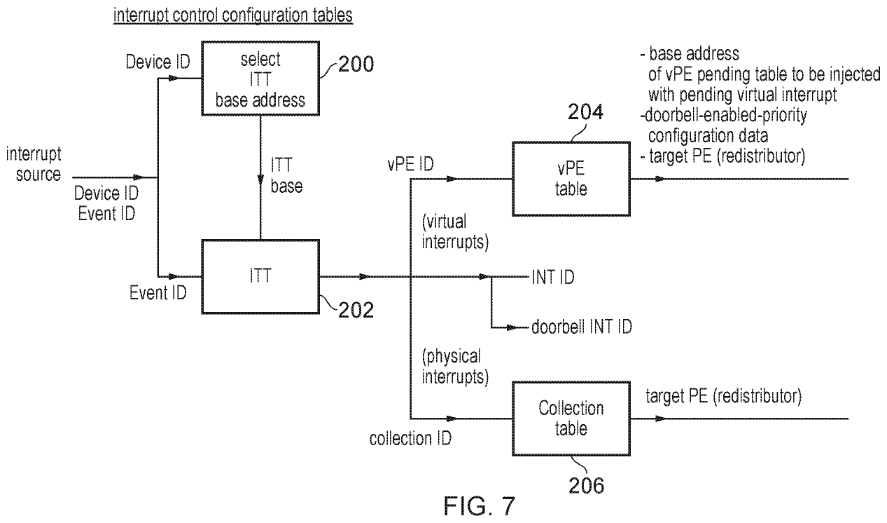

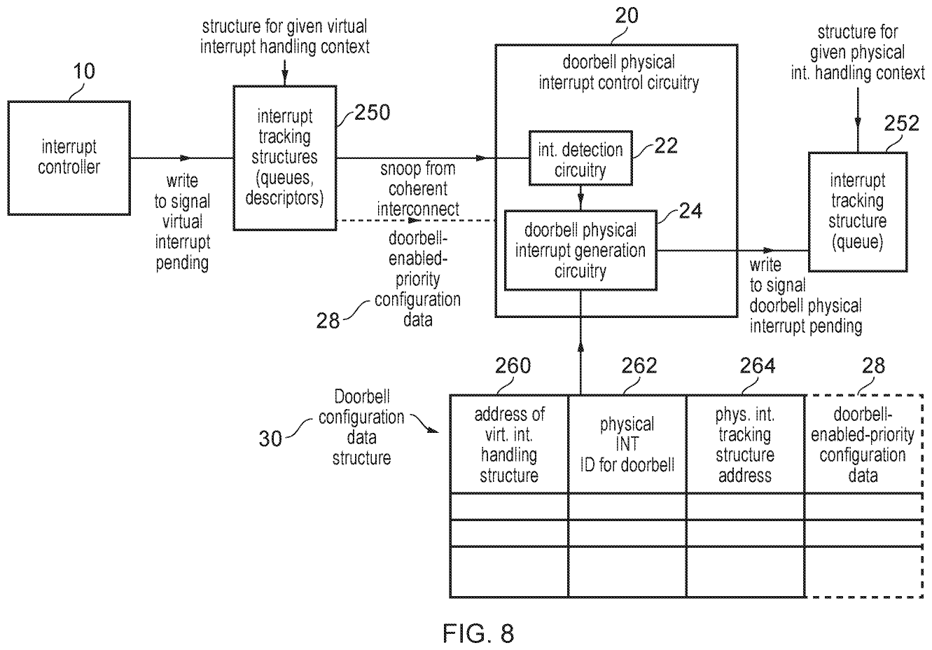

FIGS. 7 and 8 show some examples of data structures used in interrupt control, which can be used to specify the doorbell-enabled-priority configuration data;

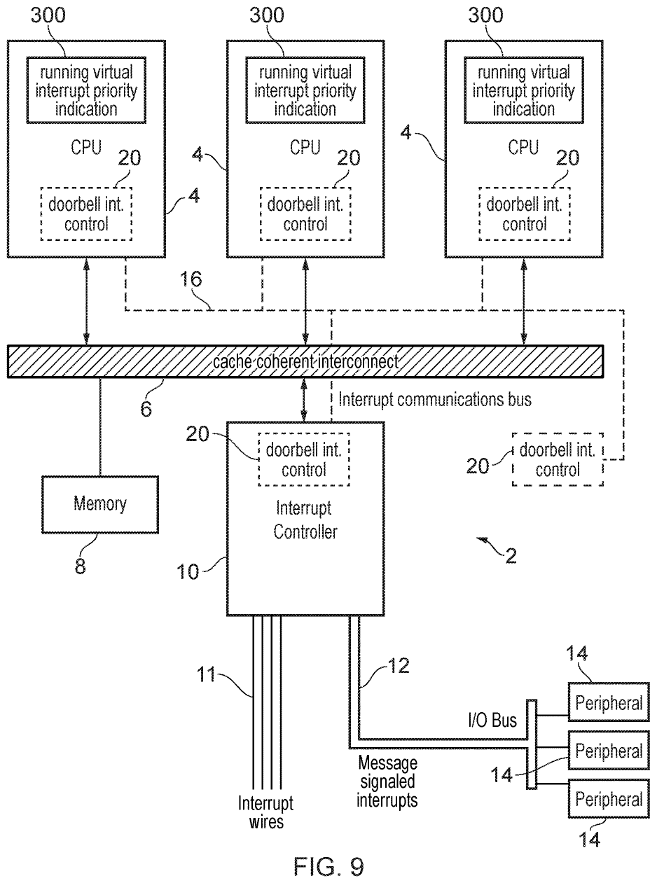

FIG. 9 illustrates maintaining a running virtual interrupt priority indication at a physical processor;

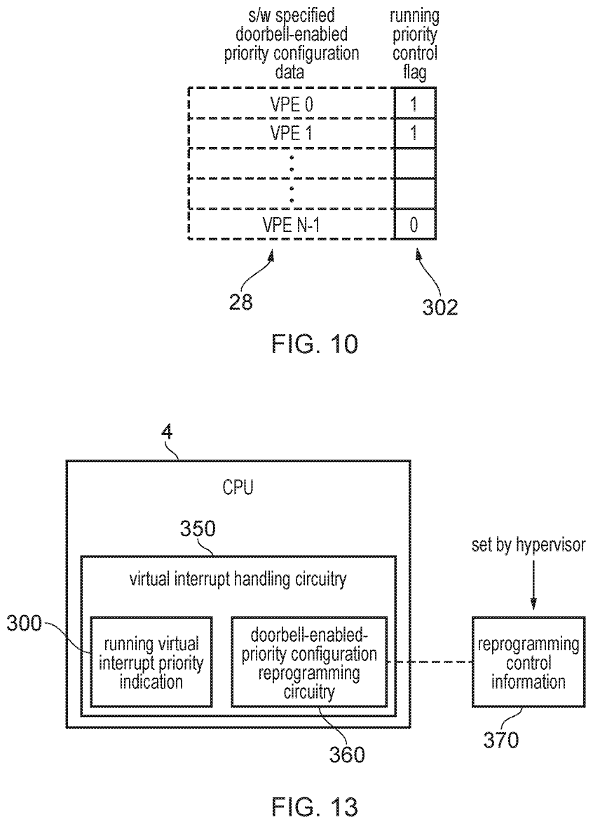

FIG. 10 illustrates hypervisor-maintained information to indicate whether the running virtual interrupt priority indication for a given physical processor should be used to determine whether to generate a doorbell physical interrupt for that given physical processor;

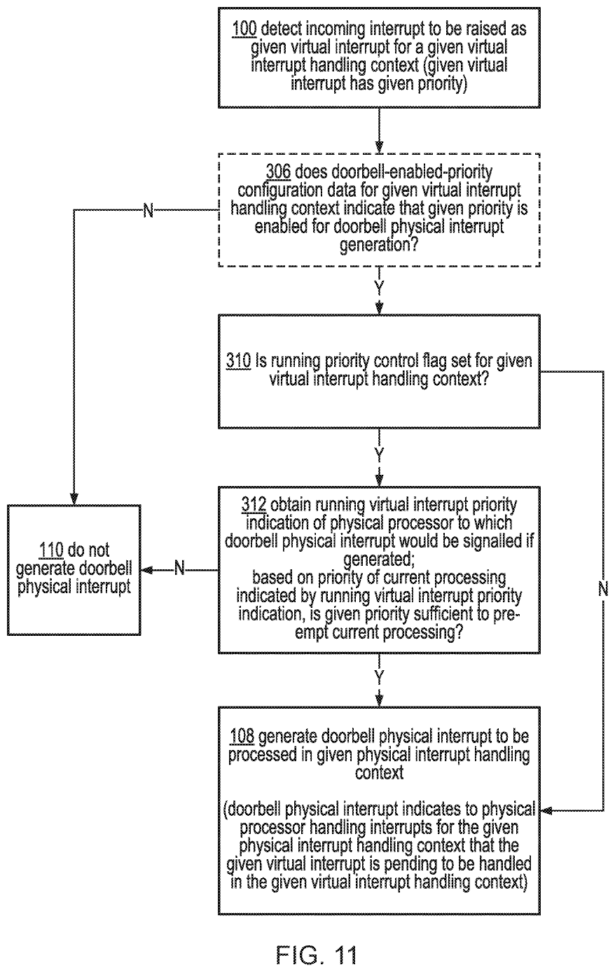

FIG. 11 illustrates a method of controlling whether to generate a doorbell physical interrupt depending on the running virtual interrupt priority indication;

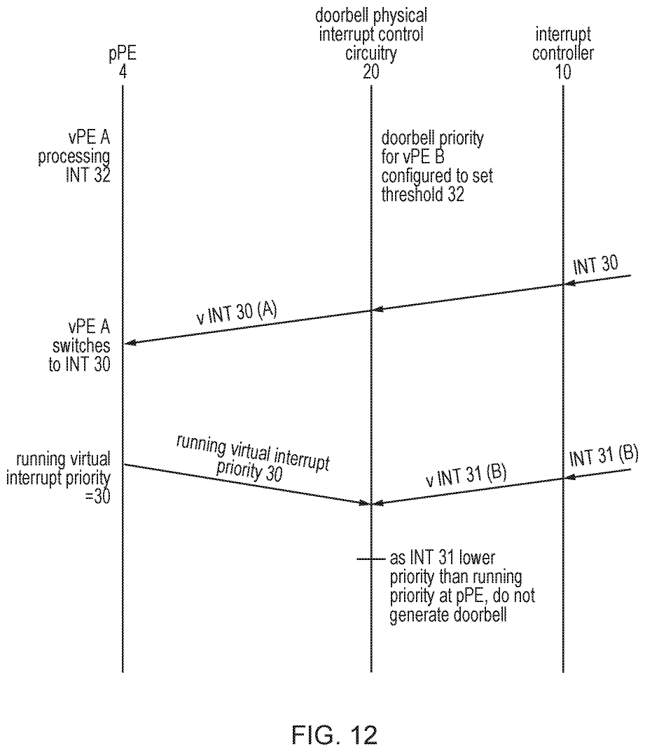

FIG. 12 is a ladder diagram illustrating an example of applying the method of FIG. 11;

FIG. 13 illustrates an example where a processor has doorbell-enabled-priority-configuration reprogramming circuitry; and

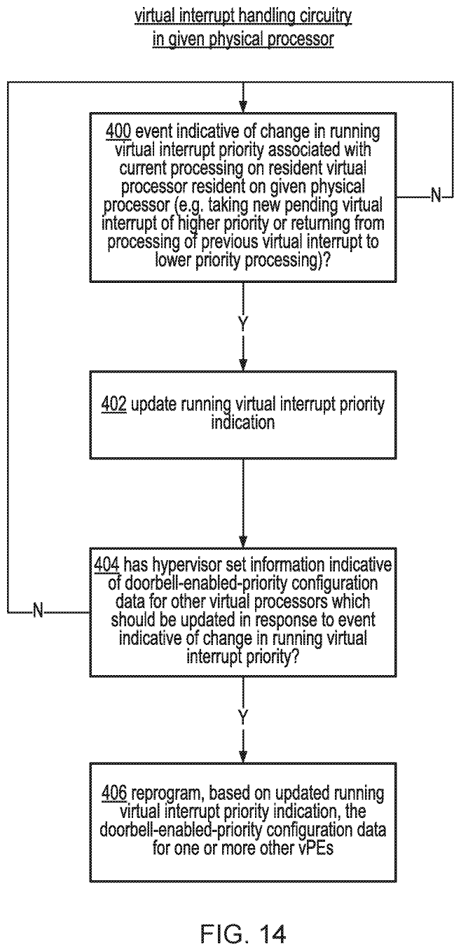

FIG. 14 illustrates a method for the doorbell-enabled-priority-configuration reprogramming circuitry to reprogram the doorbell-enabled-priority configuration information for one or more other virtual processors in response to an event indicative of a change in running virtual interrupt processor for a resident virtual processor at a given physical processor.

A physical processor may execute software corresponding to a number of virtual processors, where each virtual processor (also known as a virtual machine) may simulate the behaviour of a corresponding physical processor which could have different properties to the host physical processor actually executing the virtual processor. Interrupts may therefore be signalled either as physical interrupts to be handled by a physical processor or as virtual interrupts to be handled by a virtual processor. For example, physical interrupts may be handled by hypervisor software (the software that manages scheduling of the virtual processors executing on that physical processor) while the virtual interrupts may be handled by virtual processor software. Interrupt configuration data (e.g. set by the hypervisor software) may define which events are to be signalled using as physical interrupts and which events are to be signalled using virtual interrupts. One approach to signalling of virtual interrupts can be to involve the hypervisor in updating a given virtual processor's interrupt queue to signal that there is a pending virtual interrupt to be processed by the given virtual processor. Another approach is to use hardware to directly inject virtual interrupts into a queue corresponding to the given virtual processor, without hypervisor involvement (other than configuring the data which identifies to the hardware the location of the queue for the given virtual processor), which can be helpful for improving performance. However, if the hypervisor is not involved in the allocation of a virtual interrupt to a virtual processor's interrupt queue, a problem arises in what to do when the given virtual processor targeted by a virtual interrupt raised by the interrupt controller is not currently scheduled for execution on any physical processor. The pending virtual interrupt could represent a high priority event that needs to be dealt with promptly, but if the hardware simply updates a virtual interrupt queue structure to signal the interrupt to a non-resident virtual processor that is not currently executing, then it may not be known that it is desired to reschedule which virtual processor is executing on a physical processor, to allow the interrupt to be serviced. One approach for addressing this can be to respond to the detection of an interrupt event that is to be signalled as a virtual interrupt, by raising a physical interrupt, called a “doorbell” physical interrupt, which signals to a physical processor that there is a virtual interrupt pending for a given virtual processor not currently resident on the physical processor. The doorbell physical interrupt can prompt the hypervisor to reschedule execution on the physical processor so that the given virtual processor can execute and handle the virtual interrupt.

However, a problem with systems which generate a doorbell physical interrupt in response to detection of a pending virtual interrupt is that sometimes the doorbell physical interrupt may cause processing of a higher priority interrupt in one virtual processor to be interrupted and pre-empted by the doorbell physical interrupt raised in response to a lower priority interrupt detected for another virtual processor. While it might seem attractive to solve this problem using a shared priority space between the virtual interrupts and the physical interrupts, this can be impractical because it would require changing all software of the virtual processors and at the hypervisor level to co-operate in interrupt priority assignment, and it would break the illusion for a virtual processor that it is running in a separate isolated environment, which is important for many hypervisor designs.

In the examples discussed below, doorbell physical interrupt control circuitry comprises interrupt detection circuitry to detect an incoming interrupt to be raised as a given virtual interrupt (having a given priority) for a given virtual interrupt handling context, and doorbell physical interrupt generation circuitry responsive to detection of the incoming interrupt by the interrupt detection circuitry, to determine whether the given priority of the given virtual interrupt is indicated, by doorbell-enabled-priority configuration data indicative of which virtual interrupt priorities are enabled for doorbell physical interrupt generation, as enabled for doorbell physical interrupt generation, and if so, to generate a doorbell physical interrupt to be processed in a given physical interrupt handling context. The doorbell physical interrupt indicates to a physical processor handling interrupts for the given physical interrupt handling context that the given virtual interrupt is pending for the given virtual interrupt handling context.

Hence, circuitry is provided to control whether a doorbell physical interrupt is generated in response to a given virtual interrupt. Whether the doorbell physical interrupt is generated depends on doorbell-enabled-priority configuration data specifying which priority levels of virtual interrupts are enabled for causing a corresponding doorbell physical interrupt to be generated. Hence, a mechanism is provided to prevent doorbell physical interrupts being generated in response to virtual interrupts of a given level of priority indicated as disabled by the doorbell-enabled-priority configuration data, which can be useful, for example, to prevent lower priority virtual interrupts for one virtual processor causing a doorbell physical interrupt which might interrupt higher priority processing being performed by another virtual processor. This approach does not require any cooperation between a developer of the hypervisor software and developer of the virtual processor software in setting priority levels for particular interrupts-a shared priority space between physical and virtual interrupts can be avoided.

Each interrupt handling context refers to a certain group of interrupts which can be prioritised relative to each other based on software-defined priorities assigned to each interrupt for that interrupt handling context. The software-defined priorities for one interrupt handling context may be independent of the software-defined priorities for another.

In some implementations, each physical interrupt handling context may correspond to a particular physical processor and each virtual interrupt handling context may correspond to a particular virtual processor. In some examples, configuration information available to the doorbell physical interrupt control circuitry (or the interrupt controller described below) may identify the physical/virtual processor corresponding to a particular physical/virtual interrupt handling context.

However, for other implementations, the doorbell physical interrupt control circuitry (or the interrupt controller described below) may not actually be aware of which particular physical or virtual processor is handling the physical or virtual interrupts for a particular interrupt handling context. Hence, the physical/virtual interrupt handling context may be an abstraction which identifies a given set of interrupts, and different physical/virtual processors may be configurable to monitor particular data structures in memory used to identify the pending interrupts for a given (physical or virtual) interrupt handling context. The doorbell physical interrupt control circuitry (or the interrupt controller) may be unaware of which particular physical or virtual processor is monitoring a particular set of data structures for a given interrupt handling context. Instead, the doorbell physical interrupt control circuitry (or the interrupt controller) might identify the interrupt handling context based on, say, one or more addresses which identify the data structures used to track the interrupts for that interrupt handling context.

The doorbell-enabled-priority configuration data can be implemented in different ways. For example, the doorbell-enabled-priority configuration data could be either software-maintained information set by software, or hardware-maintained information maintained automatically by hardware without explicit software intervention (although the hardware could nevertheless control the hardware-implemented update of the doorbell-enabled-priority configuration data based on configuration data set by software). Also, the doorbell-enabled-priority configuration data could be associated with the given virtual interrupt handling context for which the given virtual interrupt is detected, or could be associated with the physical processor which would receive the doorbell physical interrupt if generated. Various examples of the doorbell-enabled-priority configuration data are described below.

In some examples, the doorbell-enabled-priority configuration data comprises software-programmable doorbell-enabled-priority configuration data associated with the given virtual interrupt handling context. The software-programmable doorbell-enabled-priority configuration data indicates, for the given virtual interrupt handling context, which priorities of interrupts are enabled or disabled for doorbell physical interrupt generation. This approach can allow a hypervisor, when switching which virtual processor is resident on a physical processor, to set the software-programmable doorbell-enabled-priority configuration data for the outgoing virtual processor to reduce the chance of higher priority processing on the newly resident virtual processor being pre-empted due to a lower priority virtual interrupt for the outgoing virtual processor.

Hence, the doorbell-enabled-priority configuration data may be defined in association with a given virtual interrupt handling context. Hence, different virtual interrupt handling contexts may have different settings for which virtual interrupt priorities would be enabled for generation of doorbell physical interrupts. A virtual interrupt of a given priority arising for one virtual interrupt handling context might trigger generation of the doorbell physical interrupt while a virtual interrupt of the same priority arising for another virtual interrupt handling context might not, depending on the doorbell-enabled-priority configuration data associated with those particular virtual interrupt handling contexts.

Hence, the doorbell physical interrupt generation circuitry may be configured to select, based on a context-identifying value associated with the given virtual interrupt handling context, the software-programmable doorbell-enabled-priority configuration data from among two or more sets of doorbell-enabled-priority configuration data associated with respective virtual interrupt handling contexts.

The context-identifying value used to select which set of software-programmable doorbell-enabled-priority configuration data to use may comprise a virtual processor identifier indicative of a virtual processor handling virtual interrupts for the given virtual interrupt handling context. Alternatively, the context-identifying value could comprise at least one address indicative of a memory location of a virtual interrupt tracking structure for tracking pending virtual interrupts for the given virtual interrupt handling context.

The sets of software-programmable doorbell-enabled-priority configuration data could be defined in one or more memory-based tables stored in a memory system. In this case, it is possible for data from those tables to also be cached in a cache local to the doorbell physical interrupt control circuitry, so that more recently accessed doorbell-enabled-priority configuration data can be accessed faster than from the underlying data in memory.

For example, each virtual interrupt handling context could have a set of corresponding memory-based interrupt tracking data structures used for indicating pending virtual interrupts for that virtual interrupt handling context, and one of these structures could also provide the software-programmable doorbell-enabled-priority configuration data for that virtual interrupt handling context (hence, each set of doorbell-enabled-priority configuration data for different virtual interrupt handling contexts could be taken from a different set of interrupt tracking data structures).

Alternatively, a data structure defining doorbell configuration information used to specify details of the doorbell physical interrupt to be generated in response to virtual interrupts for a given virtual interrupt handling context (e.g. the doorbell configuration information may specify a physical interrupt identifier to use for the doorbell physical interrupt) may also specify the software-programmable doorbell-enabled-priority configuration data for that virtual interrupt handling context.

Alternatively, the plurality of sets of software-programmable doorbell-enabled-priority configuration data could be defined in register storage. For example, a set of memory-mapped configuration registers may be associated with the doorbell physical interrupt control circuitry and can be configurable by software on a processor, by issuing memory read/write operations to addresses mapped to those registers.

The software-programmable doorbell-enabled-priority configuration data can be any information settable by software to allow the software to specify, for each interrupt priority in the given interrupt handling context, whether virtual interrupts of that priority should cause a corresponding doorbell physical interrupt to be generated. This can be represented in different ways.

In one example, the software-programmable doorbell-enabled-priority configuration data comprises a threshold value, and the doorbell physical interrupt generation circuitry determines that the given priority is enabled for doorbell physical interrupt generation when the given priority has a higher priority than a doorbell-physical-interrupt-generating threshold priority indicated by the threshold value. A threshold value can be an efficient way of encoding the software-programmable doorbell-enabled-priority configuration data to indicate, based on the comparison between a given priority and the threshold, whether each virtual interrupt priority should be treated as enabled or disabled for the purposes of generating doorbell physical interrupts. Hence, priorities of higher priority than the threshold priority represented by the threshold value are considered enabled for doorbell physical interrupt generation and priorities of lower priority than, or equal priority to, the threshold priority are considered disabled for doorbell physical interrupt generation.

The term “higher priority” is used to denote an interrupt which is more important than a lower priority interrupt. That is, an interrupt with a higher priority may pre-empt an interrupt of lower priority within the same interrupt handling context. It is noted that different encoding schemes can be used to encode the priority level for a given interrupt. In some examples, interrupts assigned a priority level with a higher numeric value may be considered higher priority than interrupts assigned a priority level with a lower numeric value (e.g. priority 4 may be considered more important than priority 3). Other examples may use a lower numeric value to indicate interrupts with a higher priority (e.g. priority 3 is higher priority than priority 4). Hence, the term “higher priority” refers to the level of importance of the interrupt, and not to the magnitude of the numeric value used to represent the priority level.

Note that the threshold priority can be represented by the threshold value in different ways—in some examples the threshold value could specify the threshold priority itself, but in other examples the threshold value could specify a priority one level higher than the threshold priority (in that case, a greater than or equals comparison between a given priority and the threshold value could indicate whether the given priority is higher priority than the threshold priority, or alternatively a less than or equals comparison could be used in the case when lower numeric values encode higher priorities than higher numeric values). Also, the threshold value may not directly indicate a threshold level, but could have an encoding which represents the threshold level indirectly (e.g. selecting from among several predetermined thresholds). Hence, in general the threshold priority may be specified in different ways and there can be a wide range of different kinds of comparison that could be used to evaluate whether a given priority is of higher priority than the threshold priority indicated (explicitly or implicitly) by the threshold value.

When the doorbell-physical-interrupt-generating threshold priority is of higher priority than the given priority, the doorbell physical interrupt generation circuitry may suppress generation of the doorbell physical interrupt even when the given virtual interrupt is signalled as pending in the given virtual interrupt handling context. Hence, the doorbell-physical-interrupt-generating threshold priority is a control specific to the generation of doorbell physical interrupts in response to virtual interrupts of a given virtual interrupt priority, rather than controlling whether the virtual interrupts are signalled as pending at all. If a virtual interrupt is signalled as pending but does not cause a corresponding doorbell physical interrupt to be generated, then handling of that virtual interrupt may be delayed because the corresponding virtual processor may not be prompted to be scheduled by the hypervisor, but eventually when that virtual processor becomes resident on a given physical processor again, the pending virtual interrupt can then be handled by that virtual processor.

In some examples, for physical interrupts, a physical interrupt mask threshold priority may be defined for comparing with the priority of a given physical interrupt to determine whether to signal the given physical interrupt to a physical processor handling interrupts for a corresponding physical interrupt handling context. Hence, some examples may provide the ability for physical interrupts of lower priority than, or equal priority to, the physical interrupt mask threshold priority to be suppressed from being signalled to the physical processor at all (even if they are pending). In such systems, the physical interrupt mask threshold priority is a separately defined threshold from the doorbell-physical-interrupt-generating threshold priority. These are different because the doorbell-physical-interrupt-generating threshold priority is compared with the priority of a virtual interrupt to determine whether to signal a doorbell physical interrupt to a physical processor, while the physical interrupt mask threshold priority is compared with the priority of a physical interrupt to determine whether to signal that physical interrupt to a physical processor.

The threshold value associated with a given virtual interrupt handling context may be settable to specify, as the doorbell-physical-interrupt-generating threshold priority, a priority other than a priority associated with a current point of program flow reached by a virtual processor handling interrupts for the given virtual interrupt handling context. This is useful because the hypervisor may be using the threshold value for the given virtual interrupt handling context to ensure that another virtual processor handling a high priority interrupt for a different virtual interrupt handling context is not interrupted unless a sufficiently high interrupt occurs for the given virtual interrupt handling context, and so the priority to be defined as the threshold value may depend more on what is being performed in the other virtual processor than on the current point of program flow reached by the virtual processor corresponding to the given virtual interrupt handling context.

A priority threshold is not the only way of defining the doorbell-enabled-priority configuration data, to indicate which priorities are enabled or disabled for the purpose of doorbell physical interrupt generation.

In another example, the software-programmable doorbell-enabled-priority configuration data comprises a set of priority indicators each corresponding to a respective priority and indicating whether that priority is enabled or disabled for doorbell physical interrupt generation. For example, the doorbell-enabled-priority configuration data can be a bitmap where each bit corresponds to a given priority level (or group of priority levels) and indicates whether that priority level or group of priority levels is enabled for doorbell physical interrupt generation (so that virtual interrupts of that priority level would trigger generation of the doorbell physical interrupt) or disabled for doorbell physical interrupt generation (so that virtual interrupts of that priority level would not trigger generation of the doorbell physical interrupt). This could allow more fine-grained control of which priority levels would cause the generation of the doorbell physical interrupt.

In some examples, the doorbell-enabled-priority configuration data comprises a running virtual interrupt priority indication indicative of a virtual interrupt priority of current processing on a resident virtual processor resident on the physical processor to which the doorbell physical interrupt would be signalled if generated.

A physical processor may have hardware circuit logic which maintains the running virtual interrupt priority indication to track the virtual interrupt priority of the current processing on the resident virtual processor currently resident on the physical processor. The resident virtual processor is the virtual processor currently assigned to that physical processor. The resident virtual processor need not be currently executing any instructions (e.g., during a system call to a hypervisor, say, instructions may be executed from the hypervisor but the resident virtual processor which made the system call may still be considered resident).

In general, a running indication of the current priority of processing performed on the resident virtual processor can be useful for the hypervisor to make scheduling decisions. Hence, some hardware circuit logic may be provided in the physical processor to respond to an event indicative of a change in virtual interrupt priority (such as a virtual interrupt being taken or a return to previous processing after completing handling of a virtual interrupt) by updating the running virtual interrupt priority indication according to the virtual interrupt priority of the processing being performed after the event.

In some examples, the running virtual interrupt priority indication for the physical processor which is to receive the doorbell physical interrupt can be used by the doorbell physical generation circuitry as the doorbell-enabled-priority configuration data, which is used to determine whether to generate the doorbell physical interrupt. Hence, in response to the detection of the incoming interrupt, the doorbell physical interrupt generation circuitry may: determine, based on the running virtual interrupt priority indication for the physical processor to which the doorbell physical interrupt would be signalled if generated, whether the given priority of the given virtual interrupt is of sufficient priority to pre-empt the current processing on the resident virtual processor; and suppress generation of the doorbell physical interrupt in response to determining that the running virtual interrupt priority indication indicates that the given priority of the given virtual interrupt is of insufficient priority to pre-empt the current processing on the resident virtual processor. By taking into account the virtual priority of the processing currently being processed on the resident virtual processor at the physical processor which would receive the doorbell physical interrupt, this can make it less likely that the doorbell physical interrupt control circuitry generates a doorbell physical interrupt which results in a lower priority virtual interrupt for a non-resident virtual processor causing an interruption to higher priority processing on the resident virtual processor.

The different approaches discussed for implementing the doorbell-enabled-priority configuration data can be implemented separately, or in combination.

Hence, in some examples, the doorbell-enabled-priority configuration data comprises the software-programmable doorbell-enabled-priority configuration data, but not the running virtual interrupt priority indication. This can provide an approach which is more easily scalable to handle different numbers of physical processors in a system (the amount of configuration data to consider by the doorbell physical interrupt control circuitry can be independent of the number of physical processors provided). Also, it allows software to set the doorbell-enabled priority configuration data for a particular virtual interrupt handling context based on any particular knowledge of current processing on a corresponding virtual processor. For example, if it is known that a particular virtual processor has no processing to perform, then the doorbell-enabled priority configuration data for the virtual interrupt handling context corresponding to that particular virtual processor could be set to disable doorbell physical interrupt generation for a greater subset of virtual interrupt priorities, to reduce the chance of doorbell physical interrupts being generated in response to virtual interrupts arising for that virtual processor.

As discussed further below, in some examples where the doorbell-enabled-priority configuration data comprises the software-programmable doorbell-enabled-priority configuration data, but not the running virtual interrupt priority indication, the running virtual interrupt priority indication may still be maintained by a given physical processor and used by hardware to control re-programming of the software-programmable doorbell-enabled-priority configuration data for one or more virtual processors. Hence, even if the running virtual interrupt priority indication is not directly considered by the doorbell physical interrupt control circuitry (e.g. to improve scalability by not requiring the running virtual interrupt priority indication for each physical processor to be routed to the doorbell physical interrupt control circuitry), the running virtual interrupt priority indication could still indirectly influence doorbell physical interrupt generation.

For other examples, the doorbell-enabled-priority configuration data may comprise the running virtual interrupt priority indication, but not the software-programmable doorbell-enabled-priority configuration data. This may allow the doorbell physical interrupt generation to respond more precisely to changes in the priority associated with the current processing performed by a resident virtual processor at a given physical processor, to reduce the likelihood that the current processing is pre-empted by a lower priority virtual interrupt arising for a non-resident virtual processor.

Other examples may consider both the software-programmable doorbell-enabled-priority configuration data associated with the given virtual interrupt handling context and the running virtual interrupt priority indication associated with the physical processor which would receive the doorbell physical interrupt if generated. In this case, the doorbell physical interrupt may be generated in response to the incoming interrupt, in response to determining that the running virtual interrupt priority indication indicates that the given priority of the given virtual interrupt is of sufficient priority to pre-empt the current processing (of the resident virtual processor interrupt on the physical processor which is to receive the doorbell physical interrupt) and the software-programmable data associated with the given virtual interrupt handling context indicates that the given priority of the given virtual interrupt is enabled for doorbell physical interrupt generation. By considering both types of doorbell-enabled-priority configuration data, more precise control of doorbell physical interrupt generation is possible (e.g. considering both any software-specific knowledge of the virtual processors'states of operation that can be used by the hypervisor in setting the software-programmable doorbell-enabled-priority configuration data, and reacting to changes in running virtual priority at a given physical processor, which can be difficult to track using the software-programmable doorbell-enabled-priority configuration data associated with a particular virtual interrupt handling context), reducing the probability of interrupting higher priority processing due to a doorbell physical interrupt generated in response to a lower priority virtual interrupt.

There are a number of ways in which the doorbell physical interrupt can be distributed to a physical processor. For example, the doorbell physical interrupt generation circuitry could distribute the doorbell physical interrupt to the physical processor by asserting a physical interrupt signal on an interrupt bus, or by updating at least one memory-based physical interrupt tracking structure to indicate that the doorbell physical interrupt is pending. Which physical processor receives the doorbell physical interrupt could be defined by doorbell physical interrupt configuration information (which could be configured independently from the virtual handling context and doorbell-enabled-priority configuration data) or could be unknown to the doorbell physical interrupt control circuitry (if updates to memory-based tracking structures are used to signal a pending doorbell physical interrupt, then the doorbell physical interrupt control circuitry may not know which physical processor is monitoring those tracking structures). The doorbell physical interrupt may have its own physical priority level which may be independent of the given priority associated with the given virtual interrupt which caused the physical interrupt to be generated.

The doorbell physical interrupt control circuitry can be implemented at a variety of different parts of a data processing system.

In one example, the doorbell physical interrupt control circuitry may be part of an interrupt controller which also comprises virtual interrupt injecting circuitry to support direct injection of virtual interrupts to a virtual processor executing on a physical processor. An interrupt controller supporting direct injection of virtual interrupts has hardware which can signal an interrupt to a virtual processor without hypervisor intervention at the time of signalling the interrupt. For example, the hardware of the interrupt controller may issue a memory access request to update a virtual interrupt queue monitored by the virtual processor, to indicate in the virtual interrupt queue that the virtual interrupt is pending. Although there is no hypervisor involvement at the time of actually signalling the virtual interrupt, this does not exclude the hypervisor being involved in setting the configuration information that controls how the hardware injects the interrupt to the virtual processor (e.g. the hypervisor may set the address of the virtual interrupt queue to be used for the virtual processor's interrupts). By providing an interrupt controller having support for direct injection of virtual interrupts with doorbell physical interrupt control circuitry, this helps the interrupt controller avoid the problem where the doorbell physical interrupt causes pre-emption of a virtual interrupt of higher priority due to detection of a virtual interrupt of lower priority.

Alternatively, the doorbell physical interrupt control circuitry could be provided in other parts of a data processing apparatus, other than the interrupt controller. For example, the doorbell physical interrupt control circuitry could be part of a physical processor, to detect virtual interrupts injected by the interrupt controller and determine whether to respond by asserting a doorbell physical interrupt to that physical processor. Also, the doorbell physical interrupt control circuitry could be a dedicated doorbell physical interrupt generating unit, separate from both the physical processor and the interrupt controller.

Hence, in general an apparatus may comprise one or more physical processors, an interrupt controller to distribute virtual interrupts and physical interrupts to the one or more physical processors, and the doorbell physical interrupt control circuitry. The doorbell physical interrupt control circuitry could be comprised by the interrupt controller, or by at least one of the one or more physical processors, or by a dedicated doorbell physical interrupt generating unit.

Each physical processor may treat physical interrupts as having a higher priority than virtual interrupts regardless of a priority specified by software for the physical interrupts or the virtual interrupts. As, in general, hypervisor events may often be considered more important than events targeting a particular virtual machine, it can be useful to by default treat physical interrupts as all having higher priority than any virtual interrupts (in the extreme case, with the lowest priority physical interrupt being considered of higher priority than the highest priority virtual interrupt). This avoids the need for cooperation between the developers of the hypervisor software and the respective virtual processor software, but can lead to the problem that a lower priority virtual interrupt for one virtual processor can cause a high priority doorbell physical interrupt to be generated which could pre-empt processing of a higher priority virtual interrupt by another virtual processor. This problem can be addressed by providing the doorbell-enabled-priority configuration data used to decide whether to signal a doorbell physical interrupt as discussed above. Hence, the technique discussed above can be particularly useful in systems which treat physical interrupts as higher priority than virtual interrupts regardless of the priority level specified by software for those interrupts.

In an implementation where the doorbell-enabled-priority configuration data comprises software-programmable doorbell-enabled-priority configuration data associated with the given virtual interrupt handling context (the software-programmable doorbell-enabled-priority configuration data indicating, for the given virtual interrupt handling context, which priorities of interrupts are enabled or disabled for doorbell physical interrupt generation), if it is desired to also consider the running virtual priority at the physical processor which is to receive the doorbell physical interrupt when determining whether to generate the doorbell physical interrupt, another approach can be that the software-programmable doorbell-enabled-priority configuration data is reprogrammed when an event occurs at a physical processor indicative of a change of running virtual interrupt priority. This can be a way of avoiding the physical routing cost of signals passing the running virtual priority indication for each physical processor to the doorbell physical interrupt control circuitry, while still allowing doorbell interrupt generation to be controlled based on the running virtual priority for a physical processor.

Hence, a given physical processor may comprise doorbell-enabled-priority configuration data reprogramming circuitry to: detect an event indicative of a change in a running virtual interrupt priority associated with the given physical processor, the running virtual interrupt priority indicative of a virtual interrupt priority associated with current processing by a resident virtual processor resident on the given physical processor, and in response to detecting the event indicative of a change in the running virtual interrupt priority, reprogram, based on an updated value for the running virtual interrupt priority after the event, a target set of software programmable doorbell-enabled-priority configuration data for one or more virtual interrupt handling contexts.

The doorbell-enabled-priority configuration data reprogramming circuitry may identify the target set of software programmable doorbell-enabled-priority configuration data based on software-programmable control information. For example, the software-programmable control information could be any information which allows hardware to identify the addresses corresponding to the memory locations to be updated based on the updated running virtual interrupt priority following an event indicative of a change in the running virtual interrupt priority (those addresses corresponding to the software-programmable doorbell-enabled-priority configuration data mentioned for one or more virtual processors). For example, the software-programmable control information could specify those addresses directly, or could specify information (such as a list of virtual processor identifiers or virtual interrupt handling context identifiers) which can be looked up in another data structure to obtain the addresses of the locations in memory to be updated with the updated running virtual interrupt priority. Hypervisor software may set the software-programmable control information, e.g. when rescheduling which virtual processor is resident on the physical processor.

A corresponding method is provided, comprising, in response to detecting that a first virtual interrupt of a first virtual interrupt handling context is to be serviced by a first virtual processor handling virtual interrupts for the first virtual interrupt handling context:
determining whether a first priority of the first virtual interrupt is higher than a current priority associated with processing performed by a second virtual processor executing on a given physical processor, the second virtual processor handling virtual interrupts for a second virtual interrupt handling context; and
in response to determining that the first priority is higher than the current priority:
   setting doorbell-enabled-priority configuration data associated with the second virtual interrupt handling context, the doorbell-enabled-priority configuration data comprising software-programmable data indicating, for the given virtual interrupt handling context, which priorities of interrupts are enabled or disabled for generation of a doorbell physical interrupt for indicating that a virtual interrupt is pending; and
   rescheduling the given physical processor to process the first virtual processor; wherein the doorbell-enabled-priority configuration data associated with the second virtual interrupt handling context is set to indicate, as disabled for generation of the doorbell physical interrupt, one or more priorities selected based on the first priority of the first virtual interrupt that detected for the first virtual interrupt handling context. This method can be performed by software for setting the doorbell-enabled-priority configuration data. This method is based on an implementation where software-programmable doorbell-enabled-priority configuration data is set corresponding to a given virtual interrupt handling context.

For example, this method can be performed by hypervisor software which is responsible for scheduling which virtual processor to execute on a given physical processor. Hence, the hardware of a data processing apparatus may not have any circuit logic dedicated to performing the steps of this method. Rather, the hardware provides the architectural functionality for responding to the doorbell-enabled-priority configuration data set by the software, e.g. by comprising the doorbell physical interrupt control circuitry described above.

In some examples, the one or more priorities, selected as disabled for generation of the doorbell physical interrupt based on the first priority of the first virtual interrupt, may comprise priorities that are of lower priority than, or equal priority, to the first priority. Hence, this would ensure that only virtual interrupts of higher priority than the first priority (which caused pre-emption of the second virtual processor) would subsequently cause a doorbell physical interrupts to be generated when a subsequent virtual interrupt is detected for the second virtual interrupt handling context handled by the second virtual processor. This approach may assume that an interrupt of a given priority in one virtual interrupt handling context may be considered equally important to an interrupt of the same priority in another virtual interrupt handling context (this may be the default assumption as the hypervisor may not be aware of the particular way in which a particular virtual processor is using the priority levels).

In other examples, if the hypervisor is aware of the relative importance of interrupts of a given priority on one virtual processor and the interrupts of a given priority on another virtual processor, there may be translation between the priority levels for the respective virtual processes and so the one or more priorities for which generation of doorbell physical interrupts are disabled could be those translated priorities in the second virtual interrupt handling context that are considered of lower priority or equal priority to the first priority of the first virtual interrupt in the first virtual interrupt handling context. Hence, the priorities selected based on the first priority might not necessarily be exclusively priorities lower than the first priority, if the hypervisor is otherwise aware that interrupts of some priorities higher than the first priority in the second virtual interrupt handling context should be prioritised ahead of an interrupt of the first priority in the first virtual interrupt handling context.

Specific examples are now described with reference to the drawings. It will be appreciated that the claims are not restricted to these examples.

FIG. 1 schematically illustrates an example of a data processing system 2 (e.g. a system on chip) comprising a number of processors 4 (e.g. central processing units, CPUs). In this example three processors 4 are shown, but it will be appreciated that the number of processors could vary. The processors communicate with each other and with shared memory 8 via a cache coherent interconnect 6 which supports a coherency protocol to maintain cache coherency of data cached in private caches of each processor 4.

An interrupt controller 10 is provided, to receive incoming interrupt signals from connected peripherals 14 and forward them to the processors 4. In some cases, processors also generate interrupts for other processors known as Inter-Processor Interrupts (IPIs), so the processors 4 themselves can also act as interrupt sources. Peripherals 14 can signal interrupts to the interrupt controller 10 either via dedicated wires 11 or by reusing an existing I/O (input/output) mechanism 12 such as memory-mapped I/O write operations. The latter is typically known as message-signalled interrupts (MSIs). The job of the interrupt controller is to prioritize interrupts according to a configuration performed by software, to ensure that a higher priority interrupt is presented to processors in preference to lower priority interrupts. On modern multi-processor systems, with more than a single processor, the interrupt controller may also have to route interrupts to one or more specified processors and handle re-programming of the routing configuration without losing interrupt signals.

The interrupt controller therefore needs to be able to communicate with the processors to which it can forward interrupts. As shown in FIG. 1, one way to implement this is to use a dedicated communication protocol and interrupt communications bus 16 in the system, which is specifically designed to carry interrupt signals from the interrupt controller 10 to the processors 4. The interrupt communications bus 16 is entirely separate from the cache coherent interconnect 6 used to convey memory transactions between the processors 4, memory 8 and interrupt controller 10 (the interrupt controller 10 may still have an interface to the cache coherent interconnect 6 to allow memory transactions issued by the processors 4 to program the configuration information which controls how the interrupt controller 10 handles forwarding of interrupts to the processors 4).

Another approach for distributing interrupts to processors can be that the existing cache coherency mechanism supported by the cache coherent interconnect 6 is leveraged for distribution of interrupts from the interrupt controller 10 to the processor 4, and the interrupt configuration and state are represented by memory-based tables which are shared by the processors and the interrupt controller. By storing the interrupt tracking data structures (e.g. queues of pending interrupts and other configuration state such as interrupt priority and enable status for different interrupt identifiers) in memory and using the cache coherency protocol of the cache coherent interconnect 6 to ensure consistency between the view of the shared tracking data structures seen by the interrupt controller 10 and the processors 4, this means that when an interrupt changes state as a result of a message or signal received by the interrupt controller 10, then the interrupt controller can cause the interrupt to be delivered to the correct processor by simply updating the tracking data structures stored in memory. This can be done without the need of a dedicated interrupt bus 16 by using the existing cache coherency interconnect mechanisms supported by the interconnect 6. The processor 4 monitoring the tracking structures for updates can ensure that an address to be monitored is held in its cache in an “exclusive” coherency state, which ensures that any write to that address by the interrupt controller will cause the cache coherent interconnect 6 to snoop the processor's cache causing an invalidation which can be detected and used as a prompt to re-request the data for that address to be brought back into the processor's cache in the exclusive state, so that the processor can examine the updated data and use it to signal an exception to the processor which can cause software to examine the updated tracking structures more closely to determine how to process any interrupt that is signalled as pending. This coherency based approach can reduce the design effort involved in scaling the chip design to different numbers of processors and interrupts, since the scaling can be implemented by changing the size or number of structures of the data stored in memory, rather than needing to expand the wiring of a dedicated interrupt distribution bus 16.

The examples below could use either the interrupt distribution bus 16, or memory writes via the cache coherent interconnect 6, to distribute virtual or physical interrupts to the processors 4. It is not essential to use the same approach for both physical and virtual interrupts. For example, physical interrupts could be distributed via the interrupt communications bus 16 while virtual interrupts could be distributed using the interconnect 6. Alternatively, both physical and virtual interrupts may use the same type of distribution mechanism, but may be distinguished by the physical signals exchanged over the interrupt communications bus, or by updating different sets of interrupt tracking structures (a set of physical interrupt tracking structures for a given physical interrupt handling context, which a given processor 4 can be configured to monitor for updates, or a set of virtual interrupt tracking structures for a given virtual interrupt handling context, which a given virtual processor executing on a given physical processor can be configured to monitor for updates). The interrupt communications bus 16 can be omitted if both virtual and physical interrupts are distributed using memory writes via the cache coherent interconnect 6.

The apparatus 2 may include doorbell physical interrupt control circuitry 20 for controlling the generation of doorbell physical interrupts which signal to a processor that there is a pending virtual interrupt to be handled by a virtual processor not currently resident on the processor. As shown by the dotted lines in FIG. 1, the doorbell physical interrupt control circuitry 20 could be implemented at different locations in the data processing system 2. For example, the doorbell physical interrupt control circuitry 20 could be provided within the interrupt controller 20, as a stand-alone doorbell physical interrupt unit designed to respond to virtual interrupts raised by the interrupt controller by generating doorbell physical interrupts to be signalled to a processor 4, or as part of each physical processor 4. These are all alternative locations for the doorbell physical interrupt control circuitry 20 and so it will be appreciated that in a given system the doorbell physical interrupt control circuitry 20 would not be provided at all of these locations.

FIG. 2 shows the doorbell physical interrupt control circuitry 20 in more detail. The doorbell physical interrupt control circuitry comprises interrupt detection circuitry 22 which detects occurrence of an incoming interrupt which is to be signalled as a virtual interrupt. In the case where the doorbell physical interrupt control circuitry 20 is provided within the interrupt controller 10, the interrupt detection circuitry 22 could detect the occurrence of the interrupt based on signals asserted on the interrupt wires 11 or using message signalled interrupts represented by memory writes requests issued on the I/O bus 12. If the doorbell interrupt control circuitry 20 is provided as a stand-alone unit or within the processors 4, the interrupt detection circuitry 22 could detect the virtual interrupt either based on a physical signal asserted on the interrupt communications bus 16 by the interrupt controller 10, or based on an update made by the interrupt controller 10 to a memory address allocated for representing interrupt tracking data (in an example where the coherency mechanism is used to deliver interrupts from the interrupt controller 10 to processors as discussed above).

The doorbell physical interrupt control circuitry 20 also includes doorbell physical interrupt generation circuitry 24 for responding to the interrupt detection circuitry 22 detecting an incoming interrupt to be signalled as a virtual interrupt, by determining whether a doorbell physical interrupt should be signalled, and if so raising the doorbell physical interrupt and signalling it to a physical processor.

If the doorbell physical interrupt control circuitry 20 is part of the interrupt controller 10, the interrupt controller may also have virtual interrupt injecting circuitry 26 which responds to detection of the interrupt raised by peripherals 14 or other sources of interrupt events to inject the virtual interrupt into a virtual interrupt queue associated with a corresponding virtual processor. Hence, the interrupt controller would support direct injection of virtual interrupts, where hardware is provided to directly update a memory structure representing a queue of virtual interrupts for a given virtual processor, without requiring hypervisor involvement for updating that queue. While the virtual interrupt injecting circuitry 26 is shown as part of the doorbell physical interrupt control circuitry 20 in FIG. 2, it could also be provided at other parts of the interrupt controller 10. The virtual interrupt injecting circuitry 26 would not be provided at the doorbell physical interrupt control circuitry 20 if the doorbell physical interrupt control circuitry 20 is implemented in the processor 4 or as a stand-alone unit.

The doorbell physical interrupt generation circuitry has access to doorbell-enabled-priority configuration data 28 and doorbell configuration data 30. In this example, both sets of data are software-programmable structures that can be programmed by software executing on the processor 4, for example being programmed by the hypervisor which manages execution of virtual processors (as mentioned later with respect to FIGS. 9 to 12, other examples could use hardware-maintained information maintained by a physical processor as the doorbell-enabled-priority configuration data). In the example of FIG. 2, the doorbell-enabled-priority configuration data 28 and doorbell configuration data 30 could be maintained within registers of the doorbell physical interrupt control circuitry 20 or within a memory-based data structure accessible by issuing memory requests. In the case of a memory-based structure, information from the memory-based data structure could also be cached in a cache local to the doorbell physical interrupt control circuitry 20. Memory management permissions defined at the processor 4 using page tables can be used to control the right to update the doorbell-enabled-priority configuration data 28 and doorbell configuration data 30, for example restricting permission to set the doorbell-enabled-priority configurations data to the hypervisor and denying access to virtual processors themselves.

The doorbell configuration data 30 can define information used to define the doorbell physical interrupt which should be generated when a given virtual interrupt is detected. For example, the doorbell configuration data 30 may specify a physical interrupt number for the doorbell physical interrupt, and may specify information identifying a physical interrupt handling context in which the doorbell physical interrupt is to be generated (e.g. this information may identify a particular physical processor, an identifier of a node on the interrupt communications bus 16 to which the doorbell physical interrupt is to be delivered, or a base address of a memory-based interrupt tracking structure to be updated to queue the doorbell physical interrupt).

In the example of FIG. 2, the doorbell-enabled-priority configuration data 28 comprises a number of sets of software-programmable data, each set corresponding to respective virtual interrupt handling context (e.g. a corresponding virtual processor), and providing data which defines for respective virtual interrupt priorities whether each priority is enabled for generation of doorbell physical interrupts or disabled for generation of doorbell physical interrupts. The doorbell-enabled-priority configuration data 28 has an encoding which allows a first subset of interrupt priorities to be defined as enabled for generation of doorbell physical interrupts while a second subset of interrupt priorities are defined as disabled for generation of doorbell physical interrupts. As there are multiple sets of doorbell-enabled-priority configuration data 28, each corresponding to a different virtual interrupt handling context, different virtual interrupt handling contexts may have different settings as to which interrupt priorities are enabled/disabled for doorbell physical interrupt generation. The doorbell physical interrupt generation circuitry 24 selects which set of doorbell-enabled-priority configuration data 28 based on a context identifier associated with the virtual interrupt handling context in which the incoming interrupt is detected by the interrupt detection circuitry 22. For example, the context identifier could be a virtual processor identifier or an address of a tracking structure used to represent pending interrupts for the virtual interrupt handling context.

The doorbell-enabled-priority configuration data 28 can be represented in different ways. For example, one implementation can provide, for each set of doorbell-enabled-priority configuration data, a threshold value identifying a priority threshold to be used for determining whether doorbell physical interrupts should be generated in response to a particular virtual interrupt. Higher priorities than the priority threshold may be considered enabled for doorbell physical interrupt generation and lower priorities than the priority threshold (and the priority equal to the priority threshold) may be considered disabled for doorbell physical interrupt generation. Hence, when an incoming interrupt corresponding to a given virtual interrupt is detected by the interrupt detection circuitry 22, the priority of the given virtual interrupt can be compared with the threshold value (or to a threshold derived from the threshold value) for the corresponding virtual interrupt handling context and the comparison result can be used to decide whether to trigger a doorbell physical interrupt.

In another approach, the doorbell-enabled-priority configuration data 28 for a given virtual interrupt handling context may specify a set of indicators (e.g. a bitmap) where each indicator corresponds to a given priority level and specifies whether interrupts of that priority should be considered enabled or disabled for doorbell physical interrupt generation.

The doorbell-enabled-priority configuration data 28 helps to address a problem with pre-emption of high priority interrupts that may occur in systems supporting direct injection of virtual interrupts. This problem is illustrated in FIG. 3. Consider for example two separate virtual processors, vPE A and vPE B, where vPE A has virtual interrupts, INT0 and INT2, and vPE B has a virtual interrupt INT1. Further consider that INT0 is higher priority than INT1 which is in turn higher priority than INT2 (lower number is higher priority). All physical interrupts are considered higher priority than all virtual interrupts (since hypervisor events may be considered more important than events to be handled by a given virtual processor).

Consider the following sequence of events on a single physical processor (pPE) 4, which are shown in FIG. 3:
1. vPE A is running in a non-interrupt context and the interrupt controller (or doorbell physical interrupt control circuitry 20) is configured to generate a physical doorbell when INT1 is asserted for vPE B.
2. INT1 is asserted which generates a physical doorbell to the hypervisor, which preempts vPE A's execution.
3. The hypervisor schedules vPE B to process the more important interrupt INT1, and configures a doorbell to be generated if a virtual interrupt (e.g. INT0 or INT2) is asserted to be processed by vPE A.
4. vPE B starts running the interrupt processing logic for INT1.
5. INT2 is asserted which generates a physical doorbell to the hypervisor, which preempts vPE B's execution.

Hence, a low priority interrupt, INT2, has caused the pre-emption of vPE which was processing a higher priority interrupt, INT1.

This problem can be addressed by providing the doorbell-enabled-priority configuration data 28, as this allows the hypervisor, when configuring the doorbell for vPE A, to define which priorities of virtual interrupts for vPE A should cause a doorbell physical interrupt to be generated, e.g. to define one or more lower priorities as disabled for doorbell physical interrupt generation.

FIG. 4 illustrates a method of processing an incoming interrupt. At step 100 an incoming interrupt is detected, which is to be raised as a given virtual interrupt for a given virtual interrupt handling context. The given virtual interrupt has a given priority. At step 106, the doorbell physical interrupt generation circuitry 24 determines whether the doorbell-enabled-priority configuration data 28 (which in the example of FIG. 2 is the doorbell-enabled-priority configuration data for the given virtual interrupt handling context) indicates that the given priority is enabled for doorbell physical interrupt generation. If the given priority is indicated as enabled for doorbell physical interrupt generation, then at step 108 the doorbell physical interrupt generation circuitry 24 generates a doorbell physical interrupt to be processed in the given physical interrupt handling context. The doorbell configuration data 30 can be used to determine which physical interrupt handling context should be used for raising the doorbell physical interrupt and other information about the doorbell physical interrupt, such as its interrupt identifier. The doorbell physical interrupt identifies to a physical processor that is handling interrupts for the given physical interrupt handling context that the given virtual interrupt is pending to be handled in the given virtual interrupt handling context. For example, the doorbell physical interrupt may cause the hypervisor to reschedule which virtual processor is executing on the physical processor, so that the virtual processor handling interrupts for the given virtual interrupt handling context can service the given virtual interrupt. If at step 106 the doorbell physical interrupt generation circuitry 24 determines that the given priority was disabled for doorbell physical interrupt generation, then at step 110 no doorbell physical interrupt is generated.

In some examples, a priority mask may also be supported to define a threshold priority for comparing with a priority of a pending physical interrupt to determine whether to signal that pending physical interrupt to a corresponding physical processor handling physical interrupts for a corresponding physical interrupt handling context. In such examples, if masking based on the priority mask is enabled, then at step 108 a further check may also be performed to determine whether the priority of the generated doorbell physical interrupt is higher than a threshold physical interrupt priority represented by the priority mask. Note that the threshold priority defined by the priority mask would be a separate threshold from a threshold defined by the doorbell-enabled-priority configuration data 28, in examples which use a threshold to implement the doorbell-enabled priority configuration data. This is because the (physical interrupt) priority mask would be a control applied to physical interrupts (in general, not just doorbell interrupts), and the priority mask threshold would be compared with the priority of a physical interrupt to determine whether that physical interrupt should be signalled to a processor 4. In contrast, if the doorbell-enabled-priority configuration data is defined using a threshold, that threshold is compared with the priority of a virtual interrupt to determine whether a doorbell physical interrupt should be generated.

FIG. 5 is a flow diagram showing a method of configuring the doorbell-enabled-priority configuration data 28 in the example of FIG. 2. This method is performed by software executing on a processor 4. For example, the method can be performed by the hypervisor software. It will be appreciated that the hardware of apparatus 2 does not have any hardware circuit logic for performing this method.

At step 150 of FIG. 5, the hypervisor detects that a first virtual interrupt has been raised for a first virtual interrupt handling context for which interrupts are handled by a first virtual processor. For example, the hypervisor may detect the first virtual interrupt because the first virtual interrupt has caused a doorbell physical interrupt to be delivered to the physical processor that was executing the first virtual processor, and this causes the hypervisor to be executed. The first virtual interrupt has a first priority. In response to the detection of the first virtual interrupt, at step 152, the hypervisor detects whether the first priority is higher than the current priority associated with processing on a second virtual processor which was resident on the given physical processor (executing before the interruption to process the hypervisor) and is handling virtual interrupts for a second virtual interrupt handling context. If the first priority is not higher than the current priority of the processing on the second virtual processor then at step 158 the hypervisor returns processing to the second virtual processor and the second virtual processor continues processing the task having the current priority.

On the other hand, if the first priority is higher than the current priority, then at step 154 the hypervisor configures the doorbell configuration data 30 to define a doorbell physical interrupt which is to be generated in response to virtual interrupts detected targeting the second virtual interrupt handling context (for which interrupts are handled by the second virtual processor will now be made non-resident on the physical processor). The hypervisor also sets the doorbell-enabled-priority configuration data 28 associated with the second virtual interrupt handling context to indicate one or more priorities selected based on the first priority (of the first virtual interrupt detected for the first virtual interrupt handling context) as being disabled for generation of the doorbell physical interrupt. Hence, note that the selection of priorities of the second virtual interrupt handling context for which doorbell physical interrupts are to be disabled depends on the first priority of the virtual interrupt detected for the first virtual interrupt handling context (rather than on the current priority of the processing that was previously being processed by the second virtual processor handling the interrupts for the second virtual interrupt handling context). This is because the purpose of disabling the doorbell physical interrupts for the second virtual interrupt handling context is to protect the first virtual interrupt handling context against interruption based on less important interrupts than the interrupt being processed by the first virtual interrupt handling context. That is, as the first virtual interrupt pre-empted the processing on the second virtual processor, it can be assumed that any virtual interrupts for the second virtual processor considered of lesser importance than the first virtual interrupt should preferably not cause the doorbell physical interrupt to be generated as this would interrupt the higher priority processing now to be scheduled on the given physical processor using the first virtual processor.

In some examples, the priorities for which doorbell physical interrupt generation is disabled for the second virtual interrupt handling context may simply be the priorities lower than or equal to the first priority. This approach may assume that a given priority in the first virtual interrupt handling context can be considered for equal importance to the same priority in the second virtual interrupt handling context.

In other examples, if the hypervisor is aware of mapping between the relative importance of priority levels for the first interrupt handling context and priority levels for the second interrupt handling context, then the hypervisor can select, as the priorities to disable for generation of doorbell physical interrupts, those priorities of the second virtual interrupt handling context that map to priorities which in the first virtual interrupt handling context would be of lower than or equal priority to the first priority.

At step 156, having configured the doorbell interrupt and set the doorbell-enabled-priority configuration data 28 associated with the second virtual interrupt handling context, the hypervisor controls the given physical processor to reschedule which virtual processor is being executed, so that now the first virtual processor is processed instead of the second virtual processor. The first virtual processor can now service the first virtual interrupt that was detected at step 150.

FIG. 6 is a ladder diagram showing the same scenario as in FIG. 3, but now applying the doorbell-enabled-priority configuration data 28 to suppress generation of a doorbell physical interrupt when a virtual interrupt (for which a corresponding doorbell physical interrupt has been configured using the doorbell configuration data 30) is detected which has an interrupt priority which is indicated by the doorbell-enabled-priority configuration data 28 is being disabled for doorbell physical interrupt generation.

Hence, in FIG. 6:
1. vPE A is running in a non-interrupt context and the interrupt controller (or doorbell physical interrupt control circuitry 20) is configured to generate a physical doorbell when INT1 is asserted for vPE B.
2. INT1 is asserted which generates a physical doorbell to the hypervisor, which preempts vPE A's execution.
3. The hypervisor schedules vPE B to process the more important interrupt INT1, and configures a doorbell to be generated if a virtual interrupt is asserted to be processed by vPE A. At this time, the hypervisor also sets the doorbell-enabled-priority configuration data 28 to indicate that priorities lower than or equal to INT1 are disabled for generation of doorbell
4. vPE B starts running the interrupt processing logic for INT1.
5. INT2 is asserted, but unlike in FIG. 3, as the doorbell-enabled-priority configuration data 28 specifies that interrupt priority 2 is disabled for generation of doorbell physical interrupts, no doorbell physical interrupt is generated and so vPE B is not interrupted and can continue to process the higher priority interrupt INT1. In contrast, if the asserted interrupt for vPE A had been the higher priority interrupt INTO then a doorbell physical interrupt would still have been generated.

FIG. 7 shows a first example of interrupt control configuration tables which could be used to define the doorbell-labelled-priority configuration data 28. An interrupt raised by an interrupt source 14 specifies a device identifier (ID) identifying the interrupt source and an event ID identifying the type of event which has occurred (which can be used to select the interrupt identifier of the interrupt which is signalled in response to that event). The device ID is used to select an interrupt translation table (ITT) base address 200, from among a number of base addresses defined for different devices (interrupt sources). Hence, different ITT structures can be used for different interrupt sources, which is useful because different interrupt sources may use the same event ID to refer to different events which need to be mapped to different interrupts.

The event ID is used to select an entry from the ITT 202 accessed using the base address 200, and the selected ITT entry provides a number of pieces of information about the interrupt to be generated, including for example:
an interrupt ID for the interrupt to be generated in response to the event;
an indication of whether the interrupt is to be signalled as a virtual interrupt or physical interrupt;
if the interrupt is to be signalled as a virtual interrupt, a virtual processor ID (vPE ID) indicating the virtual processor (virtual interrupt handling context) that is to service the virtual interrupt, and, if a doorbell interrupt has been configured for this virtual interrupt, a doorbell interrupt ID to be used for the doorbell physical interrupt to be generated when this virtual interrupt is raised;
if the interrupt is to be signalled as a physical interrupt, a collection ID which is used to select an entry from a collection table 206 which maps each collection ID to an identifier of a corresponding physical processor (or alternatively, an interrupt redistributor ID which identifies the node of the integrated circuit to which the interrupt is to be distributed by the interrupt controller). Hence, each collection ID corresponds to a collection of interrupt IDs to be distributed to the same physical processor. This helps with physical routing of the interrupt in an embodiment which uses an interrupt distribution bus 16 for distribution of interrupts. In an embodiment which uses memory writes and the coherency mechanism to distribute interrupts via the cache coherent interconnect 6, the collection table 206 may instead provide a base address of a data structure used to track the physical interrupts for a given physical interrupt handling context in which the physical interrupt is to be raised.

For a virtual interrupt, the virtual processor ID selects an entry from a virtual processor table 204 which provides information including:
a base address of that virtual processor's interrupt pending table which is to be injected with the pending virtual interrupt;
a target physical processor ID (or alternatively an interrupt redistributor ID) which identifies the physical processor or circuit node to which the doorbell interrupt is to be distributed in an embodiment using the interrupt distribution bus 16 (alternatively, the vPE table 204 may identify a base address of a data structure used to track the physical interrupts for a given physical interrupt handling context in which the doorbell physical interrupt is to be raised).
the doorbell-enabled-priority configuration data 28 for the corresponding virtual processor (virtual interrupt handling context).
   Hence, in this example the doorbell-enabled-priority configuration data 28 for a given virtual interrupt handling context is provided by the entry in the virtual processor table 204 which corresponds to the virtual processor handling the interrupts for the given virtual interrupt handling context.

It will be appreciated that the table structures and the information provided in each table as shown in FIG. 7 are just one example, and other examples could organise this information in a different way or provide other types of information in the tables. The tables 202, 204, 206 may be memory-based table structures that can be set by software to control routing of interrupts.

FIG. 8 shows a second example of data structures which can be used to control generation of doorbell physical interrupts. This example may be used when the doorbell physical interrupt control circuitry 20 is implemented at the processor 4 or as a stand-alone unit separate from the interrupt controller 10. In this example, the interrupt controller 10 distributes virtual and physical interrupts by updating corresponding memory-based interrupt tracking structures 250, 252 by issuing memory write requests on the cache coherent interconnect 6, which causes the interconnect to snoop caches of one or more processors 4 which hold the corresponding address in an exclusive state in their cache, and the invalidation of the cached data triggered by the snoop can be detected by the processor 4 so that the processor 4 can learn of the pending interrupt. Hence, when a virtual interrupt needs to be signalled, the interrupt controller 10 writes to the set of interrupt tracking structures 250 for a given virtual interrupt handling context in which the virtual interrupt is to be raised. The interrupt detection circuitry 22 of the doorbell physical interrupt control circuitry 20 detects the pending virtual interrupt, for example based on a snoop generated by the coherent interconnect 6, and this causes the doorbell physical interrupt generation circuitry 24 to generate the doorbell physical interrupt if a doorbell physical interrupt has been configured using the doorbell configuration data 30 and the doorbell-enabled-priority configuration data 28 for the given virtual interrupt handling context specifies that the given priority of the given virtual interrupt is enabled for doorbell physical interrupt generation. If the doorbell physical interrupt is generated, then the doorbell physical interrupt generation circuitry 24 writes to the set of interrupt tracking structures 252 for the corresponding physical interrupt handling context to signal that the doorbell physical interrupt is pending. A physical processor 4 monitoring an address in that structure 252 can therefore detect the physical interrupt and this may prompt a hypervisor at that physical processor to reschedule virtual processor execution to handle the original virtual interrupt that was signalled by the interrupt controller 10.

FIG. 8 shows two examples of how the doorbell-enable-priority configuration data 28 could be provided to the doorbell physical interrupt control circuitry 20. In one example, the doorbell-enabled-priority configuration data 28 could be provided within the set of interrupt tracking structures 250 for the given virtual interrupt handling context. For example, an interrupt descriptor table defining information (e.g. enable status, priority) about each interrupt identifier for the corresponding virtual interrupt handling context could also include a value specifying the doorbell-interrupt-generating priority threshold, or specify indicators of whether each priority is enabled/disabled.

In another example, the doorbell-enabled-priority configuration data 28 could be provided within part of the doorbell configuration data structure 30 used to define other information for generating the doorbell physical interrupt. For example, the doorbell configuration data structure 30 may comprise an address 260 of the virtual interrupt handling structure 250 for the virtual interrupt handling context for which doorbell interrupts are to be generated, the physical interrupt number 262 of the doorbell interrupt, and a physical interrupt tracking structure address 264 identifying the physical interrupt tracking structure 252 in which the doorbell interrupt is to be signalled as pending. Hence, when a virtual interrupt is detected from an interrupt tracking structure 250 corresponding to the address 260 specified by a given entry of the doorbell configuration data structure 30, the priority of the virtual interrupt is compared with the doorbell-enabled-priority configuration data 28 in that entry to determine whether that priority is enabled for doorbell physical interrupt generation, and if so then the doorbell physical interrupt having the physical identifier 262 is signalled by updating the tracking structure 252 represented by address 264.

There can also be other ways in which the doorbell-enabled-priority configuration data 28 could be provided. For example, the doorbell-enabled-priority configuration data 28 could be defined in a further data structure stored in memory, separate from both the virtual interrupt tracking structures 250 and the doorbell configuration data structure 30. Also, the doorbell-enabled-priority configuration data 28 could be stored in memory-mapped registers of the doorbell physical interrupt control circuitry 20.

FIG. 9 shows another example of system 2, which is the same as in FIG. 1, but in this example each physical processor 4 also maintains a running virtual interrupt priority indication 300 indicating the virtual interrupt priority of current processing on a resident virtual processor resident on that physical processor. In this example, the running virtual interrupt priority indication 300 maintained by each physical processor can be exposed to the doorbell interrupt control circuitry 20 for use in determining whether to generate a doorbell physical interrupt signalled to the corresponding physical processor.

FIG. 10 illustrates an example of hypervisor-maintained information to indicate whether the running virtual interrupt priority indication for a given physical processor should be used to determine whether to generate a doorbell physical interrupt for that given physical processor. This information is accessible to the doorbell interrupt control circuitry 20 and may be set by hypervisor software executing on one of the physical processors 4 (e.g. by writing to memory addresses allocated for the structure providing the hypervisor-maintained information). As shown in FIG. 10, for each virtual processor (or each virtual interrupt handling context), the doorbell physical interrupt control circuitry 20 has access to a corresponding running priority control indicator (e.g. a flag) 302 set by the hypervisor to indicate whether generation of doorbell physical interrupts should depend on the running virtual interrupt priority indication 300 of the physical processor to which the doorbell physical interrupt would be signalled if generated. The hypervisor may set the flags 302 so that, for example, a resident virtual processor does not have its running priority control flag 302 set, and non-resident virtual processors whose doorbell generation should not depend on the running virtual interrupt priority indication 300 also do not have their running priority control flag 302 set, but non-resident virtual processors for which the running virtual interrupt priority indication 300 should be considered when generating doorbell interrupts can have their running priority control flag 302 set.

Hence, if the virtual processor (or virtual interrupt handling context) for which the virtual interrupt is to be signalled as pending has the corresponding running priority control flag 302 set, then once the physical processor to which the doorbell interrupt is to be sent is identified (e.g. based on the collection table 206 looked up based on the doorbell interrupt identifier as shown in FIG. 7), the running virtual interrupt priority indication 300 of that physical processor is checked to identify the priority of the running virtual interrupt at that physical processor. The doorbell interrupt control circuitry 20 uses the running virtual priority to determine whether the virtual interrupt is of sufficient priority to justify generating the doorbell physical interrupt. For example, the doorbell interrupt control circuitry 20 can assume that both the resident virtual processor and the non-resident virtual processor which would handle the incoming interrupt have equivalently set levels of priority, and so may generate the doorbell physical interrupt if the virtual interrupt to be signalled has a higher priority than the priority indicated by the running virtual interrupt at the physical processor that would be sent the doorbell physical interrupt if generated.

As shown by the dotted lines in FIG. 10, in some examples, there is no need to provide the software-specified doorbell-enabled-priority configuration data 28 (provided per virtual interrupt handling context) in an embodiment which uses the running virtual priority indication to control generation of the doorbell physical interrupt.

Other examples may still provide the doorbell-enabled-priority configuration data 28 per virtual interrupt handling context, and determine whether to generate the doorbell physical interrupt based on both the software-specified doorbell-enabled-priority configuration data 28 for the given virtual interrupt handling context in which the virtual interrupt is to be signalled as pending and on the running virtual interrupt priority of the corresponding physical processor to be sent the doorbell physical interrupt—in that case the doorbell physical interrupt is suppressed if either the software-specified doorbell-enabled-priority configuration data 28 for the given virtual interrupt handling context or the running virtual interrupt priority of the corresponding physical processor indicates that the virtual interrupt to be signalled as pending in the given virtual interrupt handling context is of insufficient priority to justify generation of the doorbell interrupt. As described earlier for the configuration data 28 itself, the running priority control flags 302 could be maintained in various structures, e.g. in the interrupt tracking structures 250 or in the doorbell configuration data structure 30.

FIG. 11 illustrates a method. Steps 100, 108 and 110 are the same as in FIG. 4. In this example, in response to the incoming interrupt being detected at step 100, at step 306 an optional check is included to check whether the software-specified doorbell-enabled-priority configuration data 28 specified for the given virtual interrupt handling context indicates that the given priority is enabled for doorbell physical interrupt generation. This is similar to step 106 of FIG. 4 in the example of FIG. 2 which provides the software-specified doorbell-enabled-priority configuration data 28. If the software-specified doorbell-enabled-priority configuration data 28 indicates that the given priority is disabled for doorbell physical interrupt generation (e.g. the given priority does not exceed the threshold indicated by the software-specified doorbell-enabled-priority configuration data 28), then at step 110 the doorbell physical interrupt is not generated. If the software-specified doorbell-enabled-priority configuration data 28 indicates that the given priority is enabled for doorbell physical interrupt generation, the method proceeds to step 310. Also, in an embodiment which does not support the software-specified doorbell-enabled-priority configuration data 28, step 306 is omitted and the method proceeds direct from step 100 to step 310.

At step 310, the doorbell interrupt control circuitry 20 determines whether the running priority control flag 302 for the given virtual interrupt handling context has been set by the hypervisor software. If not, then the method proceeds to step 108 where the doorbell physical interrupt is generated in the same way as discussed for step 108 of FIG. 4.

If, at step 310, the doorbell interrupt control circuitry 20 determines that the running priority control flag 302 for the given virtual interrupt handling context has been set by the hypervisor software, then at step 312 the doorbell interrupt control circuitry 20 obtains the running virtual interrupt priority indication 300 of the physical processor 4 to which the doorbell physical interrupt would be signalled if generated. The doorbell interrupt control circuitry 20 determines, based on the priority (of the current processing on the resident virtual processor resident on that physical processor) indicated by the running virtual interrupt priority indication 300, whether the given priority of the given virtual interrupt is sufficient to pre-empt the current processing on the resident virtual processor. Some implementations may assume that the resident virtual processor and the virtual processor which is to process the given virtual interrupt have equivalent virtual interrupt priorities and so the doorbell interrupt control circuitry 20 may determine that the given priority is sufficient to pre-empt the current processing when the given priority is of higher priority than the priority indicated by the running virtual interrupt priority indication 300. Other examples may support translating priority levels using mapping information settable by software to indicate how to map between priority levels for the resident virtual processor and the priority levels for the virtual processor which is to process the given virtual interrupt.

In an implementation which implements both the checks at steps 306 and 310/312, while FIG. 11 shows these being done sequentially with step 306 first and then steps 310/312 if step 306 passes, other examples may perform the checks in the opposite order, or in parallel.

FIG. 12 is a ladder diagram showing a scenario which can make use of the ability to consider running virtual priority when deciding whether to generate a doorbell physical interrupt. This example assumes for simplicity that each virtual processor vPE A, vPE B has virtual interrupt priorities set so that a priority level X for virtual processor vPE A can be regarded as equivalent to the same priority level X for virtual processor vPE B. In this example, a physical processor (pPE) is currently processing instructions from a resident virtual processor (vPE A). The current processing corresponds to a virtual interrupt with priority level 32 (in this example, lower numeric values of interrupt priority are considered to be of higher priority than higher numeric values). An incoming interrupt is detected by the interrupt controller 10 which causes a virtual interrupt with priority level 30 to be signalled as pending to the resident virtual processor vPE A. This pre-empts the previous processing with priority level 32 and so the running virtual interrupt priority indication 300 on the physical processor pPE is updated to indicate that the running virtual interrupt priority is now priority 30.

Another incoming interrupt is then detected by the interrupt controller 10, and this interrupt is to be signalled as a virtual interrupt with priority level 31 to a non-resident virtual processor vPE B. The doorbell physical interrupt control circuitry 20 determines that the running priority control flag 302 is set for vPE B and therefore compares the virtual interrupt priority 31 of the virtual interrupt for vPE B with the priority 30 indicated by the running virtual interrupt priority of the physical processor which is to receive the doorbell interrupt. As the virtual interrupt priority 31 of the virtual interrupt to be signalled to vPE B is of lower priority than the running virtual priority 30 of the physical processor, the doorbell physical interrupt is not generated. This avoids interrupting the higher priority processing at pPE 4 based on a lower priority interrupt for a non-resident virtual processor vPE B. vPE B can instead service the interrupt either when it next becomes resident, or when vPE A finishes servicing the interrupt with priority 30, vPE A may return to processing the interrupt with priority 32, and at that point the running virtual interrupt priority for the physical processor becomes 32 again and so the doorbell physical interrupt control circuitry 20 may now detect that the interrupt for vPE B is of sufficient priority to justify generating the doorbell interrupt.

FIG. 13 shows a further example for allowing the doorbell physical interrupt control circuitry 20 to take into account the running virtual interrupt priority indication 300 of a physical processor without needing to directly expose the running virtual interrupt priority indication 300 to the doorbell physical interrupt control circuitry 20. Instead, the virtual interrupt handling circuitry 350 within a given physical processor 4, which maintains the running virtual interrupt priority indication 300, may also have doorbell-enabled-priority configuration reprogramming circuitry 360 which updates the software-defined doorbell-enabled-priority configuration data 28 for one or more virtual interrupt handling contexts, so that the corresponding items of doorbell-enabled-priority configuration data 28 can track the latest running virtual interrupt priority at that physical processor 4. Hence, while software may set the doorbell-enabled-priority configuration data 28 initially, e.g. based on the method of FIG. 5, the reprogramming circuitry 360 may also update this data 28 in hardware. This approach can avoid needing to route the running virtual interrupt priority indication 300 of each physical processor to the doorbell physical interrupt control circuitry 20 in an implementation where the doorbell physical interrupt control circuitry 20 is provided centrally separate from the physical processors 4. The doorbell-enabled-priority configuration reprogramming circuitry 360 has access to reprogramming control information 370 set by the hypervisor software, which specifies information for identifying the target set of doorbell-enabled-priority configuration data 28 to be updated when the running virtual processor at that physical processor changes. For example, the reprogramming control information 370 could be a list of addresses to be updated with updated values for the running virtual priority, or could be a list of vPE identifiers which can be used to look up the vPE table 204 to find the doorbell-enabled-priority configuration data, for example. The hypervisor could update the list of information 370 when rescheduling virtual processors on the physical processor.

Hence, in this example the control of whether to generate the doorbell physical interrupt can be as shown in FIG. 4, based on the doorbell-enabled-priority configuration data 28 set by software for the virtual interrupt handling context for which the given virtual interrupt is to be signalled as pending. There is no need to consider the running virtual priority of the physical processor which is to receive the doorbell physical interrupt, as shown in FIG. 11.

However, the software-set doorbell-enabled-priority configuration data 28 can be modified in hardware by the doorbell-enabled-priority configuration reprogramming circuitry 360 when there is an event indicating a change in the running virtual interrupt priority at the resident virtual processor being processed by a given physical processor and the doorbell-enabled-priority configuration data 28 is one of the items of doorbell-enabled-priority configuration data 28 specified by reprogramming control information 370 as to be updated in response to such an event. Hence, in a scenario similar to that of FIG. 12, the change in running virtual priority at the physical processor 4 due to vPE A switching to processing a higher priority virtual interrupt can be reflected in the doorbell-enabled-priority configuration data 28.

FIG. 14 shows a method performed by the virtual interrupt handling circuitry 350 at a given physical processor 4. At step 400, an event is detected which is indicative of a change in running virtual interrupt priority associated with the current processing on a resident virtual processor resident on the given physical processor 4. For example, the event could be taking a pending virtual interrupt of higher priority or returning to lower priority processing after processing a previously taken virtual interrupt. At step 402, the virtual interrupt handling circuitry 350 of the physical processor 4 updates the running virtual interrupt priority indication 300 to account for the change in running priority following the event detected at step 400.

At step 404, the virtual interrupt handling circuitry 350 determines whether the hypervisor has set the reprogramming control information 370 (e.g. a data structure in memory at an address set in a configuration register of the virtual interrupt handling circuitry 350) which indicates doorbell-enabled-priority configuration data 28 to be updated in response to an event indicating a change in running virtual interrupt priority. If no valid reprogramming control information 370 has been set, the method returns to step 400 to await another event.

However, if valid reprogramming control information 370 has been set, then at step 406, the doorbell-enabled-priority configuration reprogramming circuitry 360 reprograms, based on the updated running virtual interrupt priority indication 300, the doorbell-enabled-priority configuration data 28 for the virtual interrupt handling contexts corresponding to one or more other virtual processors (other than the resident virtual processor). The data to be updated is identified using the hypervisor-set reprogramming control information 370.

For example, the threshold set for the doorbell-enabled-priority configuration data 28 could be set corresponding to the new value of the running virtual interrupt priority indication 300 resulting from the update in step 402. Again, this provides a way of allowing the doorbell physical interrupt control circuitry 20 to determine the priority of processing currently being performed at a physical processor, to help with a decision on whether to pre-empt that processing by delivering a doorbell physical interrupt in response to a given virtual interrupt of a given level of priority.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. Doorbell physical interrupt control circuitry comprising:
interrupt detection circuitry to detect an incoming interrupt to be raised as a given virtual interrupt for a given virtual interrupt handling context, the given virtual interrupt having a given priority; and
doorbell physical interrupt generation circuitry responsive to detection of the incoming interrupt by the interrupt detection circuitry, to:
determine whether the given priority of the given virtual interrupt is indicated, by doorbell-enabled-priority configuration data indicative of which virtual interrupt priorities are enabled for doorbell physical interrupt generation, as enabled for doorbell physical interrupt generation; and
in response to determining that the doorbell-enabled-priority configuration data indicates that the given priority of the given virtual interrupt is enabled for doorbell physical interrupt generation, generate a doorbell physical interrupt to be processed in a given physical interrupt handling context, the doorbell physical interrupt comprising a physical interrupt to indicate to a physical processor handling interrupts for the given physical interrupt handling context that the given virtual interrupt is pending to be handled in the given virtual interrupt handling context.

2. The doorbell physical interrupt control circuitry according to claim 1, in which the doorbell-enabled-priority configuration data comprises software-programmable doorbell-enabled-priority configuration data associated with the given virtual interrupt handling context, the software-programmable doorbell-enabled-priority configuration data indicating, for the given virtual interrupt handling context, which priorities of interrupts are enabled or disabled for doorbell physical interrupt generation.

3. The doorbell physical interrupt control circuitry according to claim 2, in which the doorbell physical interrupt generation circuitry is configured to select, based on a context-identifying value associated with the given virtual interrupt handling context, the software-programmable doorbell-enabled-priority configuration data from among a plurality of sets of software-programmable doorbell-enabled-priority configuration data associated with respective virtual interrupt handling contexts.

4. The doorbell physical interrupt control circuitry according to claim 3, in which the context-identifying value comprises one of:
a virtual processor identifier indicative of a virtual processor handling virtual interrupts for the given virtual interrupt handling context; and
at least one address indicative of a memory location of a virtual interrupt tracking structure for tracking pending virtual interrupts for the given virtual interrupt handling context.

5. (canceled)

6. The doorbell physical interrupt control circuitry according to claim 2, in which the software-programmable doorbell-enabled-priority configuration data comprises a threshold value, and the doorbell physical interrupt generation circuitry is configured to determine that the given priority is enabled for doorbell physical interrupt generation when the given priority has a higher priority than a doorbell-physical-interrupt-generating threshold priority indicated by the threshold value.

7. The doorbell physical interrupt control circuitry according to claim 6, in which:
when the doorbell-physical-interrupt-generating threshold priority is of higher priority than the given priority, the doorbell physical interrupt generation circuitry is configured to suppress generation of the doorbell physical interrupt even when the given virtual interrupt is signalled as pending in the given virtual interrupt handling context.

8. The doorbell physical interrupt control circuitry according to claim 6, wherein the doorbell-physical-interrupt-generating threshold priority is defined separate from a physical interrupt mask threshold priority for comparing with a priority of a given physical interrupt to determine whether to signal the given physical interrupt to a physical processor handling interrupts for a physical interrupt handling context corresponding to the given physical interrupt.

9. The doorbell physical interrupt control circuitry according to claim 6, in which the threshold value is settable to specify, as the doorbell-physical-interrupt-generating threshold priority, a priority other than a priority associated with a current point of program flow reached by a virtual processor handling interrupts for the given virtual interrupt handling context.

10. The doorbell physical interrupt control circuitry according to claim 2, in which the software-programmable doorbell-enabled-priority configuration data comprises a set of priority indicators each corresponding to a respective priority and indicating whether that priority is enabled or disabled for doorbell physical interrupt generation.

11. The doorbell physical interrupt control circuitry according to claim 1, in which the doorbell-enabled-priority configuration data comprises a running virtual interrupt priority indication indicative of a virtual interrupt priority of current processing on a resident virtual processor resident on the physical processor to which the doorbell physical interrupt would be signalled if generated.

12. The doorbell physical interrupt control circuitry according to claim 11, in which, in response to the detection of the incoming interrupt, the doorbell physical interrupt generation circuitry is configured to:
determine, based on the running virtual interrupt priority indication for the physical processor to which the doorbell physical interrupt would be signalled if generated, whether the given priority of the given virtual interrupt is of sufficient priority to pre-empt the current processing on the resident virtual processor; and
suppress generation of the doorbell physical interrupt in response to determining that the running virtual interrupt priority indication indicates that the given priority of the given virtual interrupt is of insufficient priority to pre-empt the current processing on the resident virtual processor.

13. The doorbell physical interrupt control circuitry according to claim 11 in which the doorbell-enabled-priority configuration data also comprises software-programmable data associated with the given virtual interrupt handling context, the software-programmable data indicating, for the given virtual interrupt handling context, which priorities of interrupts are enabled or disabled for doorbell physical interrupt generation; and
in response to determining that the running virtual interrupt priority indication indicates that the given priority of the given virtual interrupt is of sufficient priority to pre-empt the current processing and the software-programmable data associated with the given virtual interrupt handling context indicates that the given priority of the given virtual interrupt is enabled for doorbell physical interrupt generation, generate the doorbell physical interrupt.

14. The doorbell physical interrupt control circuitry according to claim 1, in which the doorbell physical interrupt generation circuitry is configured to distribute the doorbell physical interrupt to the physical processor by one of:
asserting a physical interrupt signal on an interrupt bus; and
updating at least one memory-based physical interrupt tracking structure to indicate that the doorbell physical interrupt is pending.

15. An interrupt controller comprising:
virtual interrupt injecting circuitry to support direct injection of virtual interrupts to a virtual processor executing on a physical processor; and
the doorbell physical interrupt control circuitry according to claim 1.

16. An apparatus comprising:
one or more physical processors;
an interrupt controller to distribute virtual interrupts and physical interrupts to the one or more physical processors; and
the doorbell physical interrupt control circuitry according to claim 1.

17. (canceled)

18. The apparatus according to claim 16, in which each physical processor is configured to treat physical interrupts as having a higher priority than virtual interrupts regardless of a priority specified by software for the physical interrupts or the virtual interrupts.

19. The apparatus according to claim 16, in which the doorbell-enabled-priority configuration data comprises software-programmable doorbell-enabled-priority configuration data associated with the given virtual interrupt handling context, the software-programmable doorbell-enabled-priority configuration data indicating, for the given virtual interrupt handling context, which priorities of interrupts are enabled or disabled for doorbell physical interrupt generation; and
a given physical processor comprises doorbell-enabled-priority configuration data reprogramming circuitry to:
detect an event indicative of a change in a running virtual interrupt priority associated with the given physical processor, the running virtual interrupt priority indicative of a virtual interrupt priority associated with current processing by a resident virtual processor resident on the given physical processor; and
in response to detecting the event indicative of a change in the running virtual interrupt priority, reprogram, based on an updated value for the running virtual interrupt priority after the event, a target set of software programmable doorbell-enabled-priority configuration data for one or more virtual interrupt handling contexts.

20. (canceled)

21. A computer-readable medium to store code for fabrication of the doorbell physical interrupt control circuitry of claim 1.

22. A method comprising:
detecting an incoming interrupt to be raised as a given virtual interrupt for a given virtual interrupt handling context, the given virtual interrupt having a given priority; and
in response to detection of the incoming interrupt:
determining whether the given priority of the given virtual interrupt is indicated as enabled for doorbell physical interrupt generation by doorbell-enabled-priority configuration data indicative of which virtual interrupt priorities are enabled for doorbell physical interrupt generation; and
in response to determining that the doorbell-enabled-priority configuration data indicates that the given priority of the given virtual interrupt is enabled for doorbell physical interrupt generation, generating a doorbell physical interrupt to be processed in a given physical interrupt handling context, the doorbell physical interrupt comprising a physical interrupt to indicate to a physical processor handling interrupts for the given physical interrupt handling context that the given virtual interrupt is pending to be handled in the given virtual interrupt handling context.

23. A method comprising:
in response to detecting that a first virtual interrupt of a first virtual interrupt handling context is to be serviced by a first virtual processor handling virtual interrupts for the first virtual interrupt handling context:
determining whether a first priority of the first virtual interrupt is higher than a current priority associated with processing performed by a second virtual processor executing on a given physical processor, the second virtual processor handling virtual interrupts for a second virtual interrupt handling context; and
in response to determining that the first priority is higher than the current priority:
setting doorbell-enabled-priority configuration data associated with the second virtual interrupt handling context, the doorbell-enabled-priority configuration data comprising software-programmable data indicating, for the given virtual interrupt handling context, which priorities of interrupts are enabled or disabled for generation of a doorbell physical interrupt for indicating that a virtual interrupt is pending; and
rescheduling the given physical processor to process the first virtual processor;
wherein the doorbell-enabled-priority configuration data associated with the second virtual interrupt handling context is set to indicate, as disabled for generation of the doorbell physical interrupt, one or more priorities selected based on the first priority of the first virtual interrupt that detected for the first virtual interrupt handling context.

24. A computer program which, when executed by a computer, controls the computer to perform the method of claim 23.
